(19) United States
(12) Patent Application Publication
(10) Pub. No.: US 2007/0158249 A1
(43) Pub. Date: Jul. 12, 2007

(54) Dialysis machine with transport mode

(76) Inventor: Stephen R. Ash, Lafayette, IN (US)

Correspondence Address: JONES DAY, 222 E.41ST STREET, NEW YORK, NY, 10017, US

(21) Appl. No.: 11/444,036

(22) Filed: May 31, 2006

Related U.S. Application Data
(60) Provisional application No. 60/756,785, filed on Jan. 6, 2006.

(51) Int. Cl. B01D 21/30

(52) U.S. Cl. 210/138; 210/321.6; 210/143; 604/5.01

(57) ABSTRACT

A dialysis machine is provided comprising a non-volatile memory component into which patient data is stored. The patient data includes patient identification as well as prescribed patient treatment parameters. When data for a particular patient is entered by an operator into the non-volatile memory, the machine can be shut down and transported to the patient. The machine is then restarted, and performs a series of checks to ensure that all functions are ready to commence treatment. Patient treatment can then be achieved at a location remote from where the machine was first set up.

The present invention claims priority from U.S. Application Ser. No. 60/756,785 filed Jan. 6, 2006 and entitled Dialysis Machine With Transport Mode, the entirety of which is hereby incorporated by reference.

### BACKGROUND

The present invention relates to a dialysis machine for extracorporeal treatment of blood. More particularly, the invention relates to such a dialysis machine that can be transported from a set-up location to a treatment location while preserving data related to treatment parameters for one or more individuals to be treated.

Various types of medical equipment are designed with the knowledge that the equipment may be used in an ambulatory manner. For example, U.S. Pat. No. 5,317,506 issued to Coutre et al. and entitled Infusion Fluid Management System discloses an infusion management and pumping system. Infusion prescriptions are generated and monitored by a pharmacy management system. Labels for each infusion to be given to a patient are generated and printed in a bar code format. Each label contains data regarding a prescribed infusion program, including the drug or drugs to be infused, the infusion regimen, the expiration date, and the patient to whom the infusion is to be administered. The management system checks for incompatibilities between drugs that are being prescribed for simultaneous infusion. Each label generated by the management system is attached to the container which holds the infusion solution. The data on the label is transferred to an infusion pumping system by a bar code reader at the infusion pumping system. The pumping system checks that all necessary data has been entered. During operation, the pumping system checks for a variety of alarm conditions and stores any alarms in a ranking according to urgency. The infusion pumping system is responsive to remote or biofeedback instructions to alter the planned infusion program. Central computer records processing receives infusion data and provides infusion, inventory, and use analysis.

Another example is U.S. Pat. No. 5,376,070 issued to Purvis et al. and entitled Data Transfer System for an Infusion Pump. That patent discloses a data transfer system for communication with an infusion pump of the type used for programmable delivery of medication such as insulin to a patient. The data transfer system includes a communication station having a shaped pocket formed therein for seated reception of the infusion pump. Optical communication members including light emitting and detecting devices mounted on the pump and station are aligned for two-way data transmission when the pump is seated within the station pocket. The communication station can be used directly to monitor data received from the pump, and to transmit reprogrammed data to the pump, as desired. Alternately, the communication station can provide a data relay link to a remote site such as to a computer via a computer data cable, or a modem. See also U.S. Pat. No. 5,360,710 issued to Tune et al. and entitled Ambulatory Infusion Pump.

U.S. Pat. No. 6,699,230 issued to Jaafar et al. and entitled Apparatus and Method for Out-Of-Hospital Thrombolytic Therapy discloses an apparatus and method for emergency administration or self-administration of thrombolytic therapy in early stage of a heart attack. The apparatus includes a needle injector for making a venipuncture, a battery operated micro cooler for maintaining low temperature environment for vials with lyophilized thrombolytic and adjuvant drugs, a container with a diluent for reconstitution of the lyophilized drugs, a programmable infusion pump, and a microprocessor for controlling the process of infusion and recording the data. As the system is activated, the container becomes fluidly communicable with the infusion pump and vials with drugs in the cooler. Designed for autonomous execution of several schedules of infusion, it also can be controlled remotely by a qualified operator via an Internet interface.

Finally, U.S. Pat. No. 5,250,027 issued to Lewis et al. and entitled Peristaltic Infusion Device With Backpack Sensor relates to a sensed member and sensing member for use on a medical fluid infusion device and support device wherein the fluid infusion device is usable in a conventional manner such as on an IV pole and in an ambulatory manner such as in a support device for use in an ambulatory backpack. The sensing member of the present invention detects when the fluid infusion device is to be used in an ambulatory manner to adjust the operation of the infusion control member to account for the difference in fluid flow rates caused by the different fluid pressures within the fluid delivery set when the fluid infusion device is used in a conventional manner and an ambulatory manner.

Dialysis machines for the extracorporeal treatment of a patient's blood are well known. Such devices withdraw blood from a patient, circulate the blood through a treatment unit, and then return the treated blood to the patient. Dialysis machines have a number of variable parameters that are individually adjusted prior to each dialysis treatment in accordance with the prescribing physician's instructions for a particular patient. Such parameters include, for example, blood flow rate, the duration of treatment, the type of dialyzer used, the dialyzer values, the type of dialysate, the type of infusate, and values related to treatment with heparin or other anti-coagulant.

Setting up a dialysis machine prior to administration of dialysis to a patient can be a complex process. Each of the parameters identified above must be pre-set. In addition, the machine itself must be prepared. The dialyzer must be installed. Sources of heparin and saline must be connected. Separate sets of tubing must be installed to carry both blood and dialysate. The tubing must be flushed and primed. The tubing must be checked for the presence of air bubbles, and any air bubbles found must be removed. The dialysate must be warmed to a pre-determined temperature. Only when all parameters have been set and set-up is complete can dialysis treatment of a patient commence.

Because of the complexity of the dialysis machine, set-up of a dialysis machine typically is performed by a trained professional. Dialysis generally occurs in a hospital setting or a dialysis treatment center. Dialysis treatments typically last for a duration of at least three hours, and often must be performed several times per week. For some patients, daily dialysis is required.

For some dialysis patients, travel to and from a dialysis treatment location, at least several times a week, and for several hours each time, can be difficult and burdensome. Such repeated travel can be especially difficult for some patients who are already in fragile health. For such patients, it would be desirable to bring a dialysis machine either to their home or to some other location closer to their home where dialysis treatment can be performed. Even for patients who are hospitalized, the movement from the hospital room to the location of the dialysis machine in the hospital can be stressful. Yet the complexity of appropriate set-up of the dialysis machine remains a significant obstacle to the performance of dialysis treatment in a remote location, or even at a patient's bedside. Thus, a need exists for an ambulatory dialysis machine.

### SUMMARY OF THE INVENTION

A dialysis system of the present invention has a treatment mode and a transport mode. The dialysis system of the invention comprises a dialysis machine; an electronic control means; a non-volatile memory component; a data entry means for entering patient treatment parameters into the non-volatile memory; and a data display means. The dialysis machine can be prepared for dialysis treatment of a patient, with the dialysis treatment parameters for the patient entered through the data entry means for storage in the non-volatile memory component; the electronic control means then can be set to operate the system in transport mode; the system then can be removed from external power, transported to a patient location, and reconnected to external power, the electronic control means then being capable of operating the system in treatment mode in accordance with the patient treatment parameters stored in the non-volatile memory component.

In another aspect of the present invention, a method of operating a dialysis system comprises preparing the dialysis machine for treatment of a patient, entering dialysis treatment parameters for that patient via a data entry means into a non-volatile memory component, disconnecting the system from external power, transporting the system to a treatment location, reconnecting the system to external power, such that the machine will reset in accordance with the patient treatment parameters stored in the non-volatile memory component, and using the reset dialysis machine to treat the patient. In a preferred embodiment, the elapsed time between the disconnection of the system from external power and the beginning of patient treatment is monitored.

### DESCRIPTION OF THE FIGURES

For the present invention to be easily understood and readily practiced, the invention will now be described, for purposes of illustration and not limitation, in conjunction with the following figures wherein:

FIG. 1 is a legend of symbols used in the flow charts of FIGS. 2-23.

FIG. 2 is a start-up menu and main menu of the system of FIG. 24.

FIG. 3 is a system menu for off-site use of the system of FIG. 24.

FIG. 4 is a system menu for acute treatment methods using the system of FIG. 24.

FIG. 5 is a set of defaults for the acute treatment using the system of FIG. 24.

FIG. 6 is a flowchart showing editing of the system-set prescriptions for off-site use of the system of FIG. 24.

FIG. 7 is a flowchart showing the treatment set-up procedures for off-site use of the system of FIG. 24.

FIG. 8 is a flowchart showing the treatment set-up procedures of acute treatment using the system of FIG. 24.

FIG. 9 is a flow chart illustrating the calculation of a UFR value for the system of FIG. 24.

FIG. 10 is a flowchart showing the establishment of dialysate prescription values and infusate prescription values for off-site use of the system of FIG. 24.

FIG. 11 is a flowchart showing the establishment of dialysate prescription values and infusate prescription values for acute treatment using the system of FIG. 24.

FIG. 12 is a flowchart showing the procedures for the installation of disposables in the system of FIG. 24.

FIG. 13 is a flowchart showing the procedures for priming the system of FIG. 24.

FIG. 14 is a flowchart showing the procedures for confirming the use of prescribed parameters of off-site use of the system of FIG. 24.

FIG. 15 is a flowchart showing the procedures for confirming the use of prescribed parameters for acute treatment using the system of FIG. 24.

FIG. 16 is a flowchart showing dialysis treatment using the system of FIG. 24.

FIG. 17 is an Appendix to FIG. 16.

FIG. 18 is a flowchart showing post-treatment procedures using the system of FIG. 24.

FIG. 19 is a flowchart showing procedures for alarms and one alert for use with the system of FIG. 24.

FIG. 20 is a flowchart showing procedures for two additional alerts for use with the system of FIG. 24.

FIG. 21 is a flowchart showing a procedure for the recovery of the system of FIG. 24.

FIG. 22 is a flowchart showing various quit scenarios for the system of FIG. 24.

FIG. 23 is a flowchart showing procedures for adjusting the dialysate of the system of FIG. 24.

FIG. 24 is a schematic view of an embodiment of a dialysis system of the present invention.

### DETAILED DESCRIPTION OF A PREFERRED EMBODIMENT

The dialysis system shown schematically in the drawings has parts that are examples of the elements recited in the apparatus claims, and can be operated in steps that are examples of the elements recited in the method claims. The illustrated system thus includes examples of how a person of ordinary skill in the art can make and use the claimed invention. They are described here to meet the enablement and best mode requirements of the patent statute without imposing limitations that are not recited in the claims.

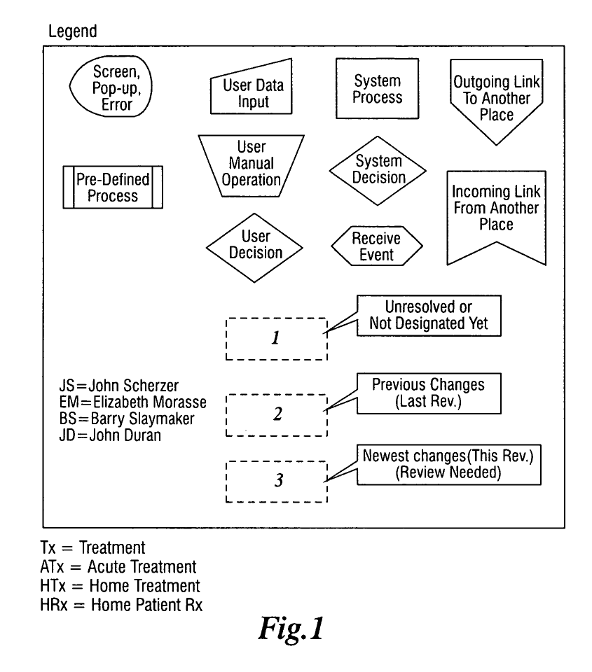

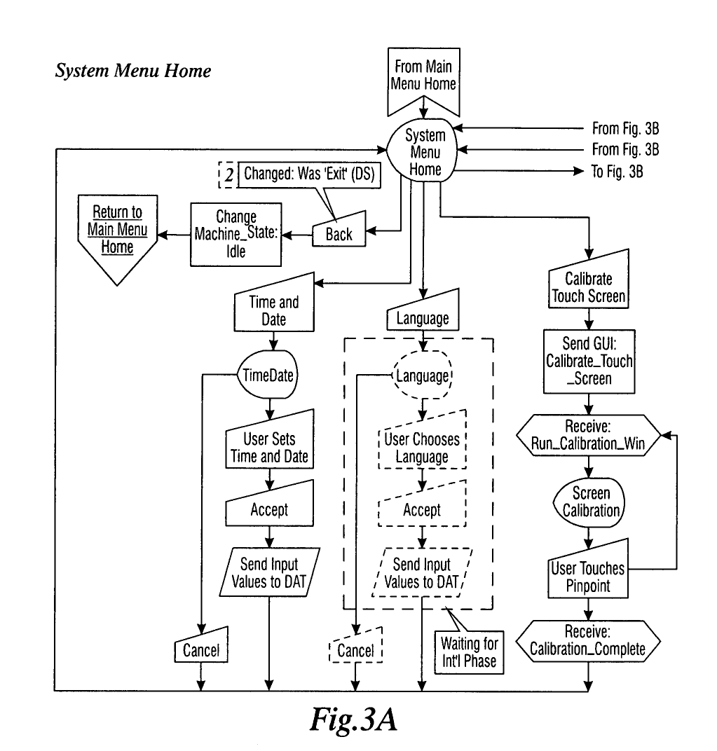

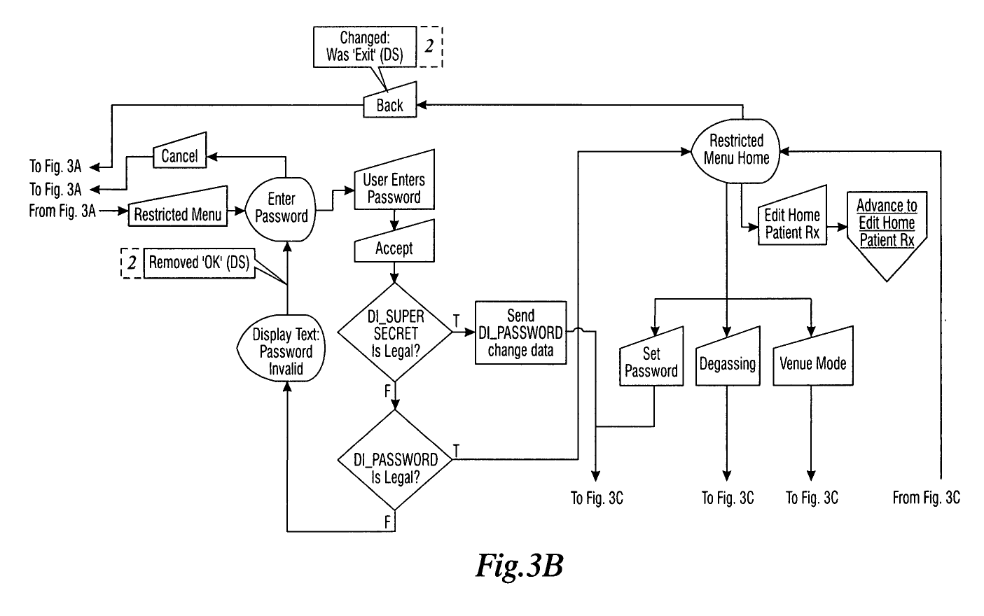

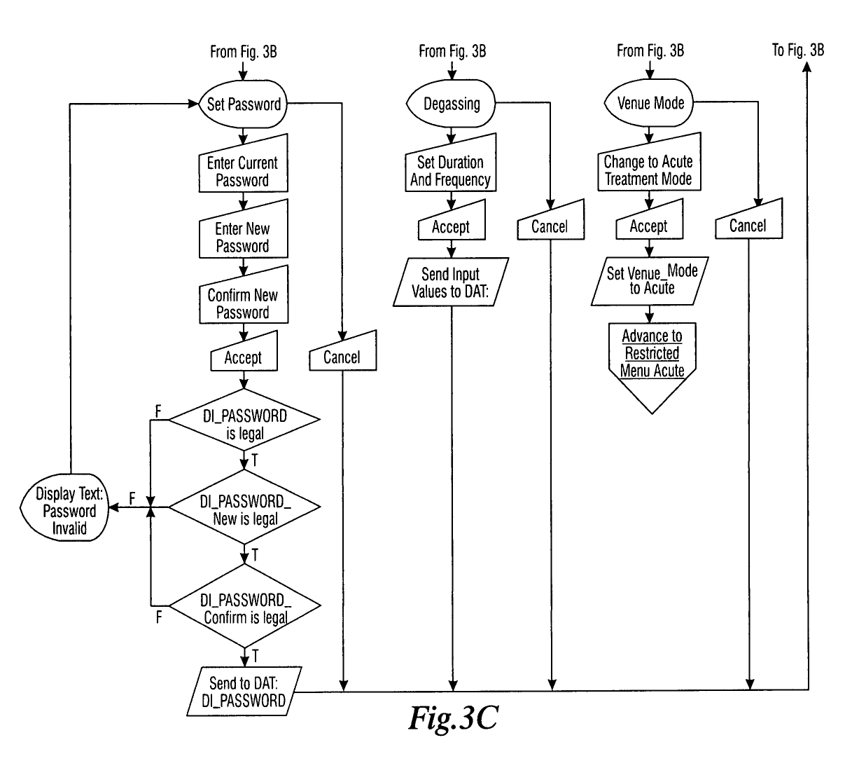

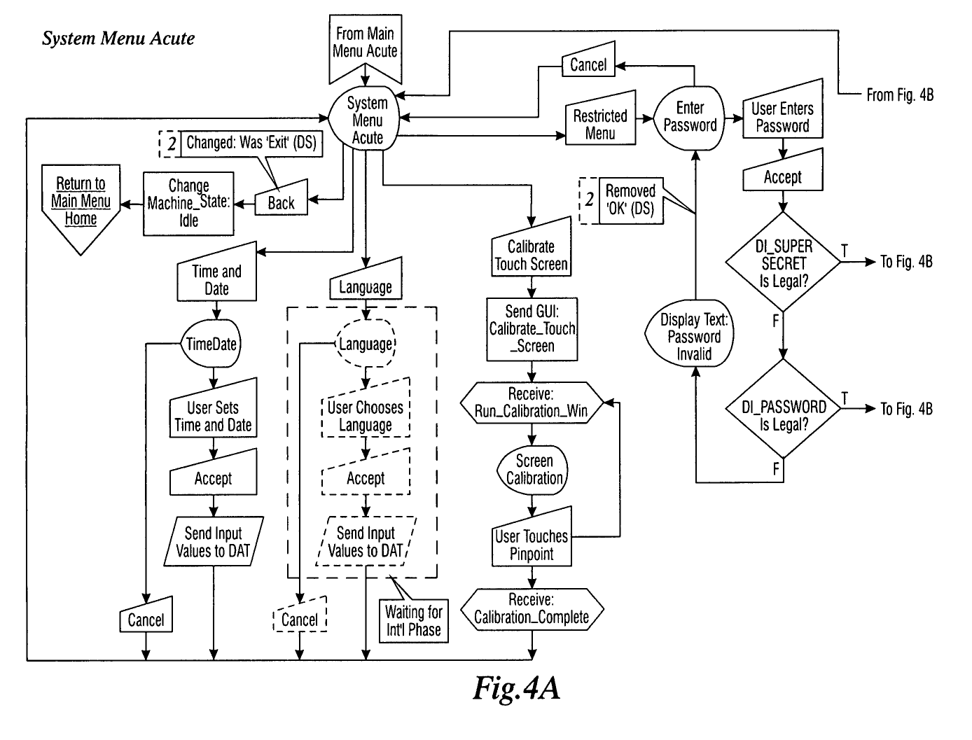

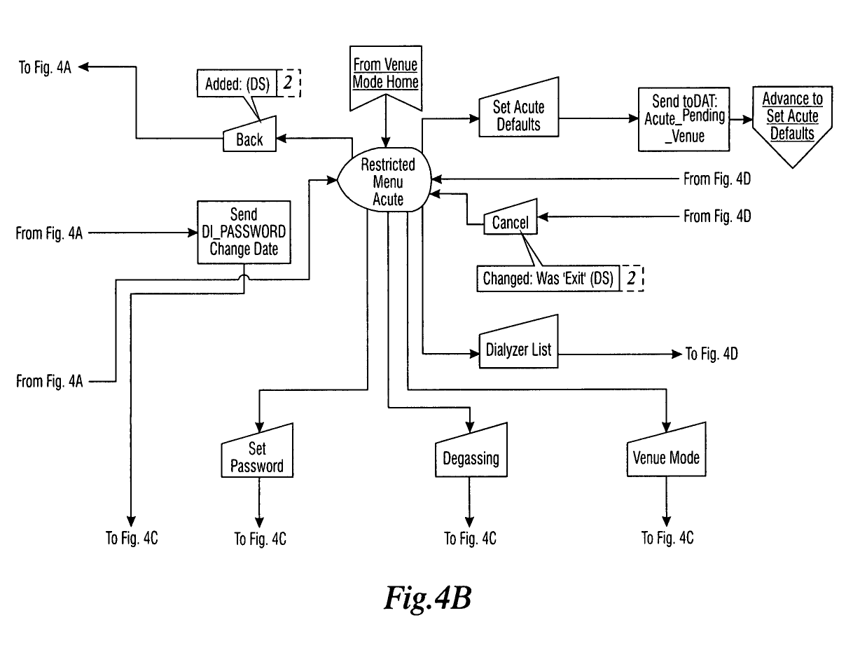

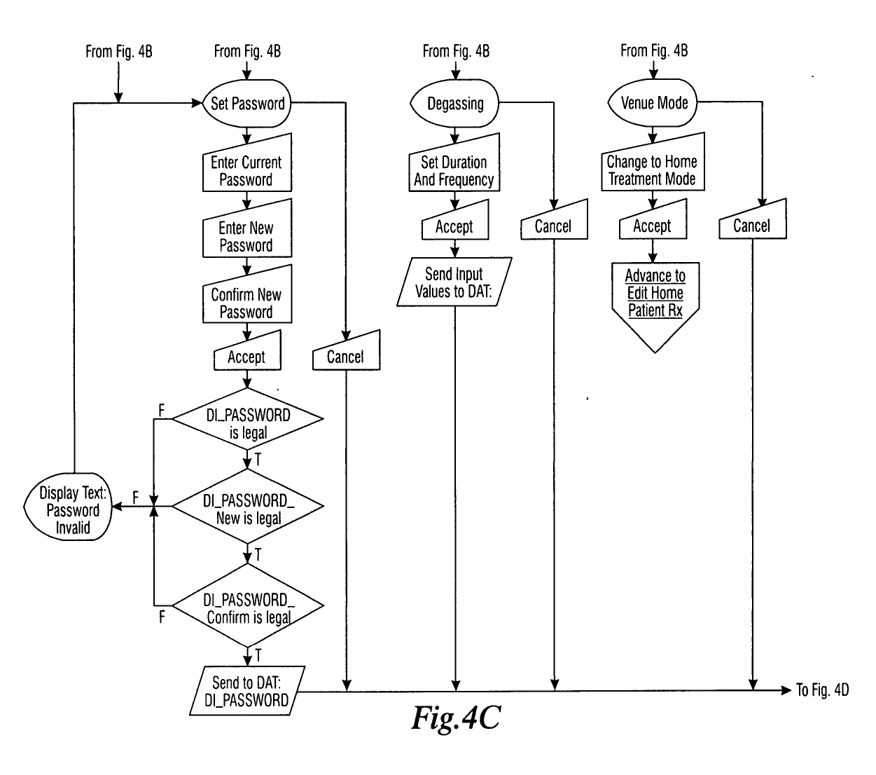

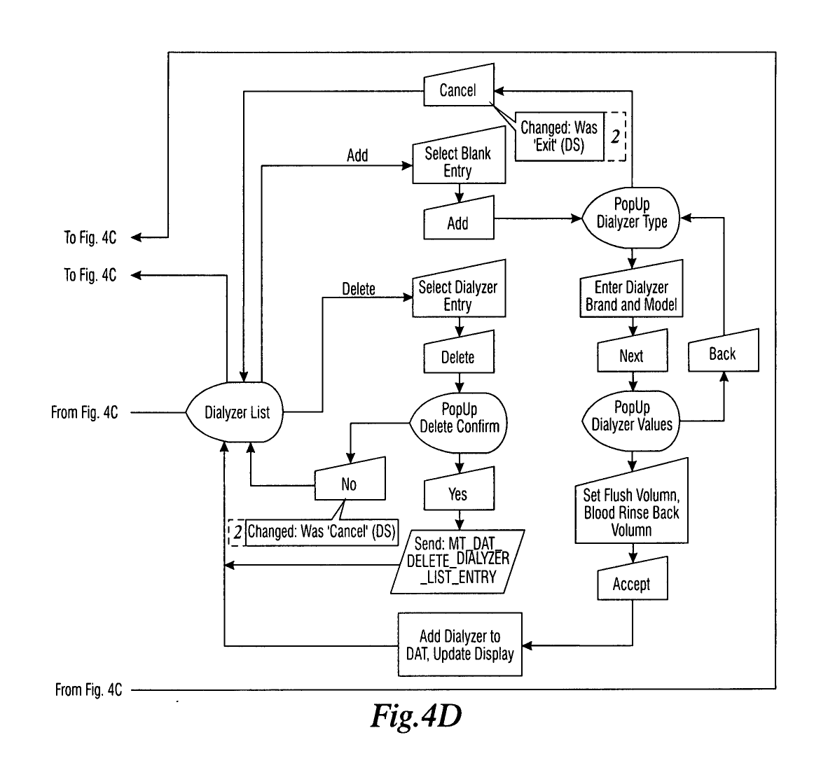

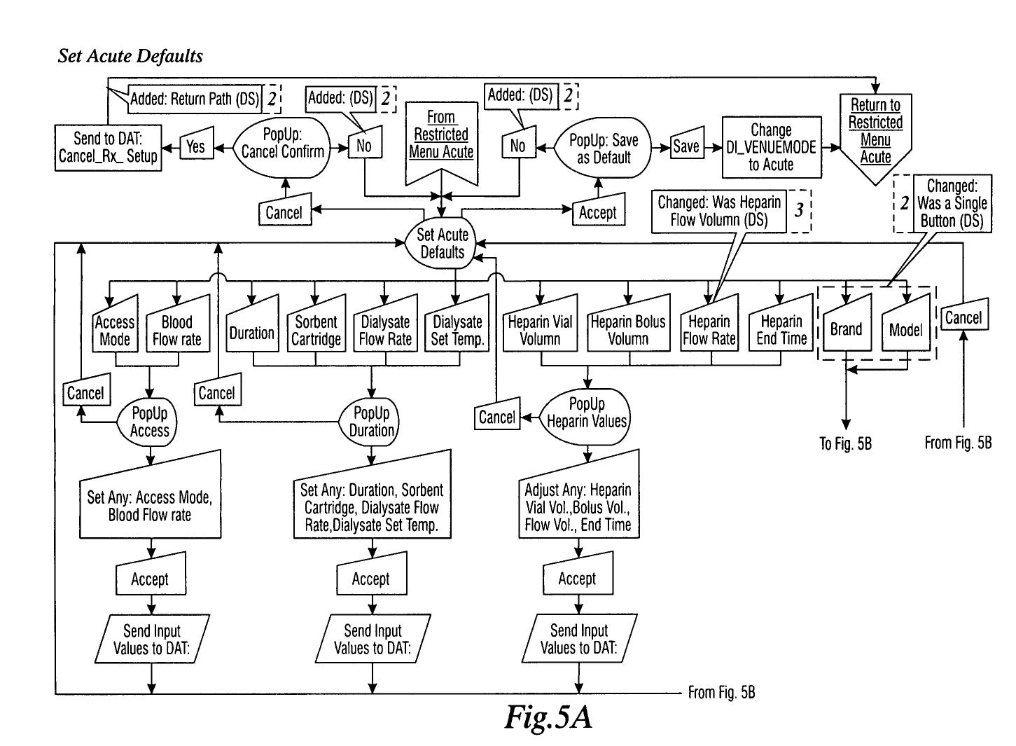

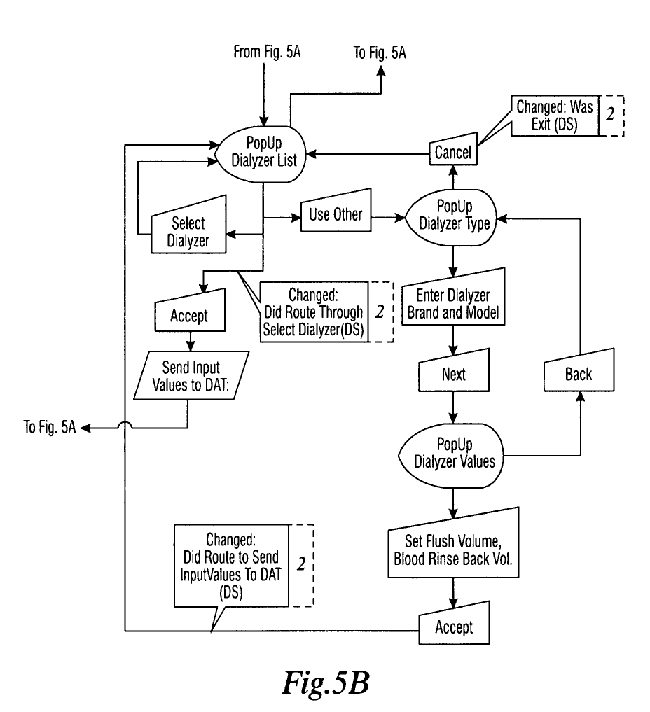

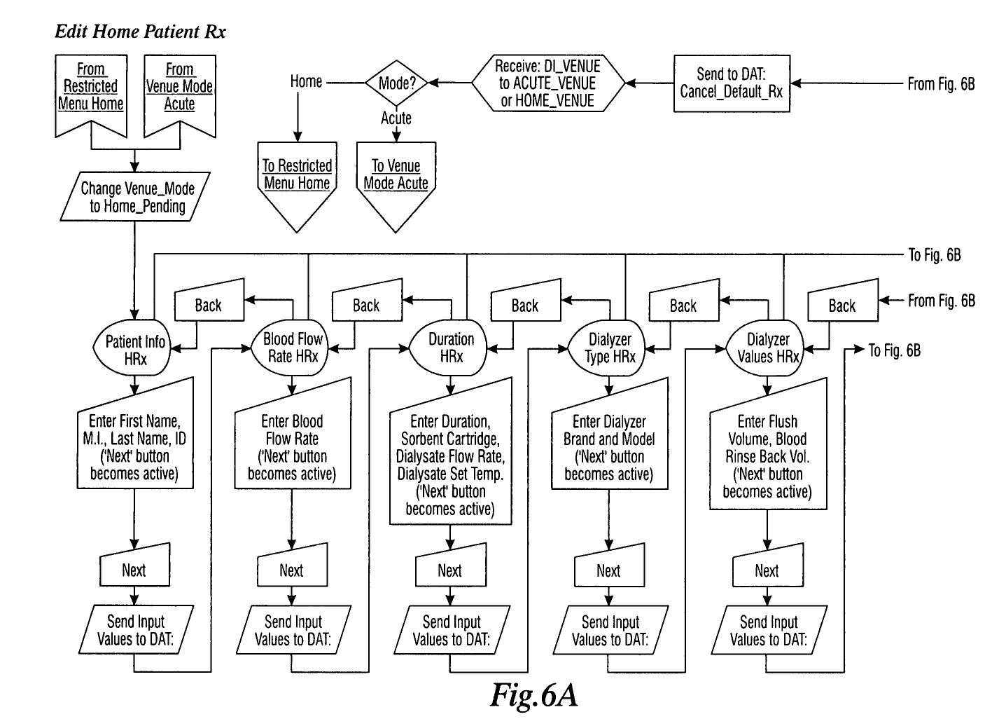

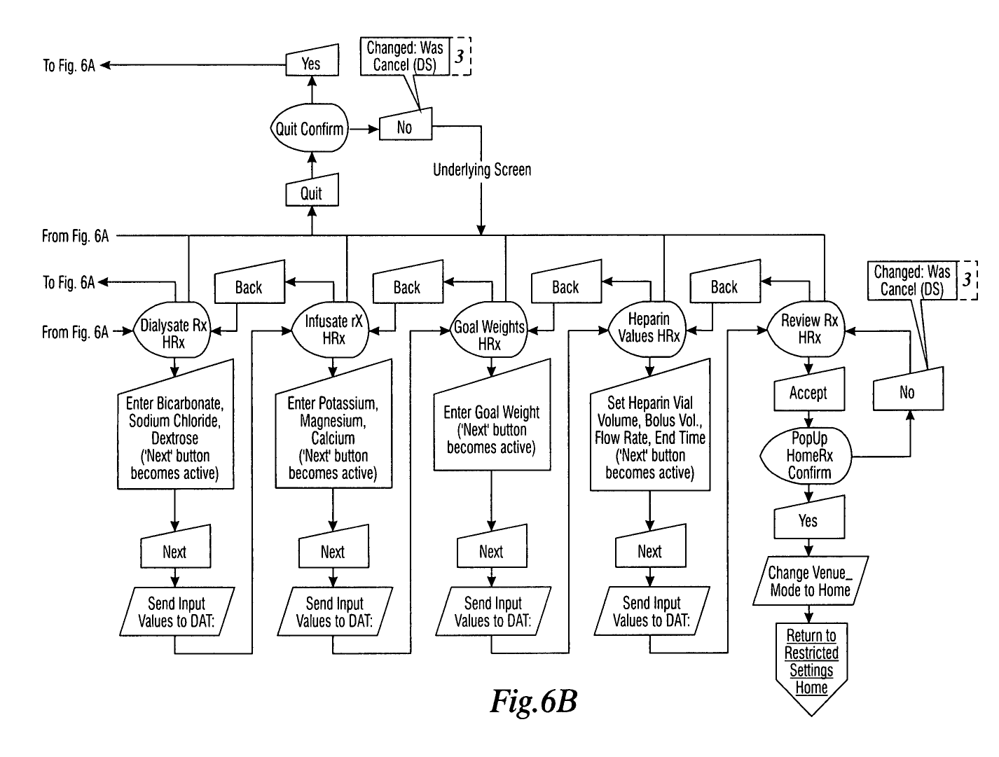

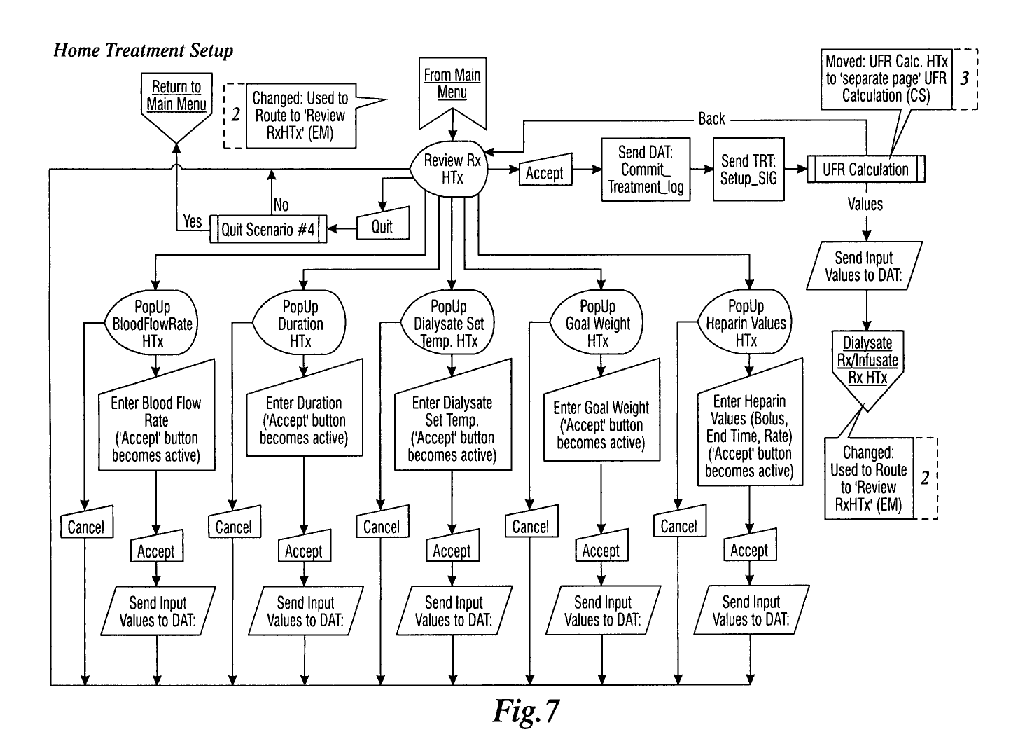

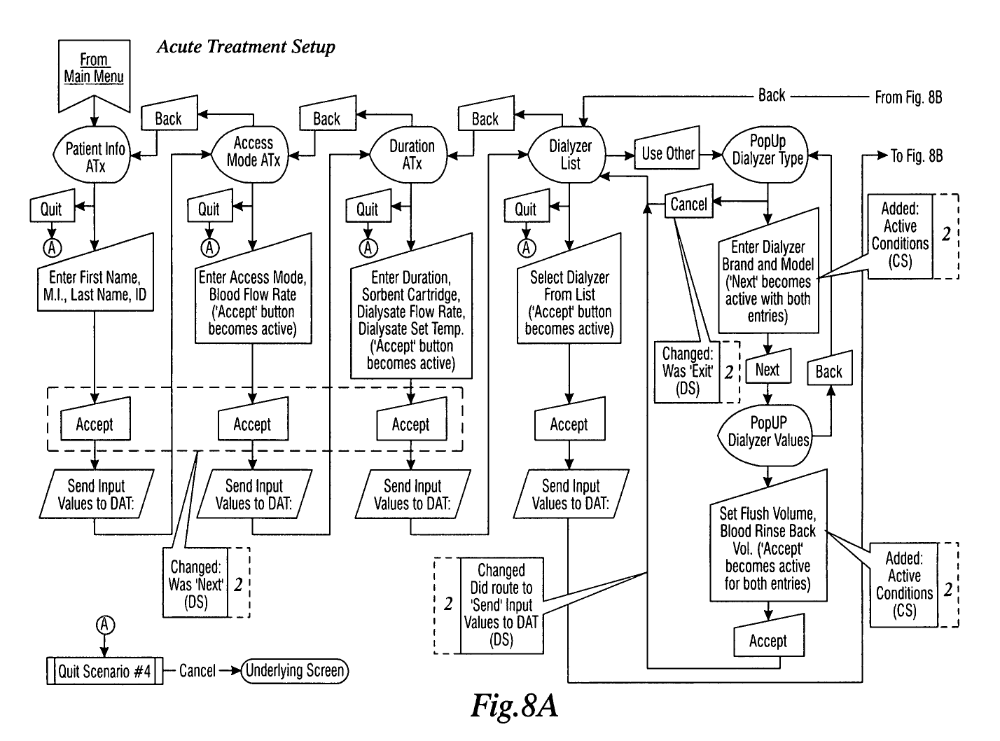

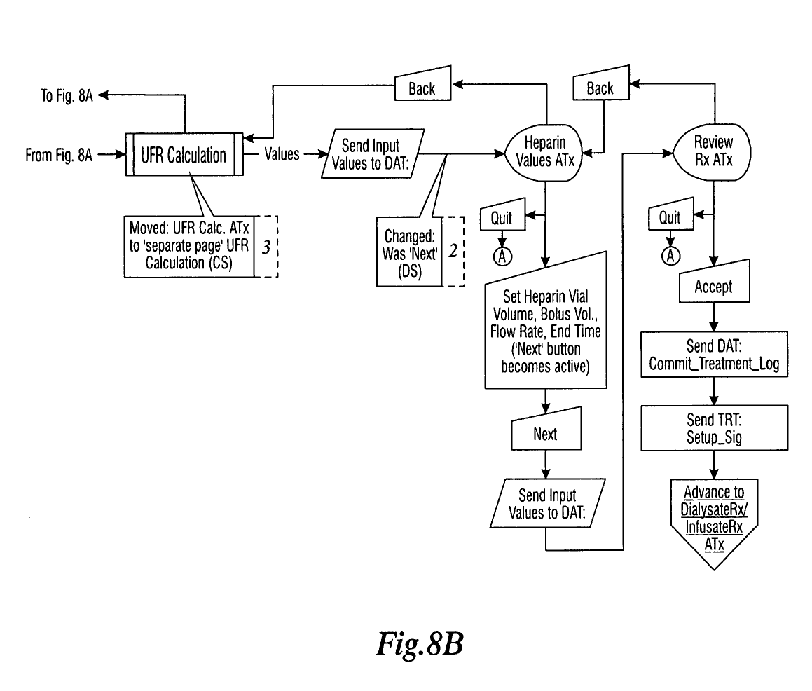

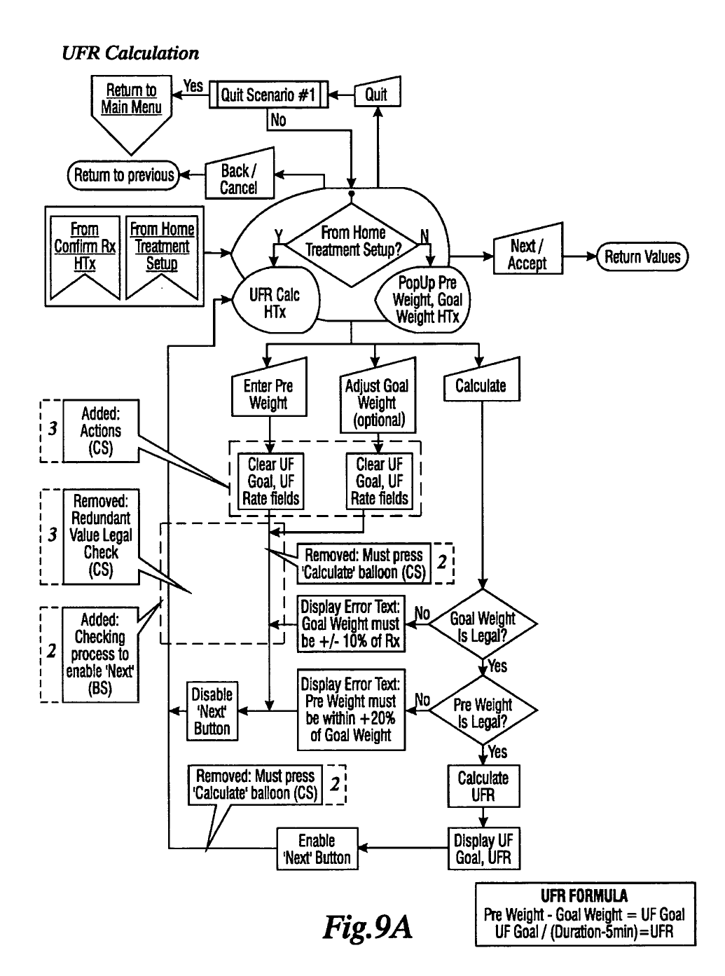

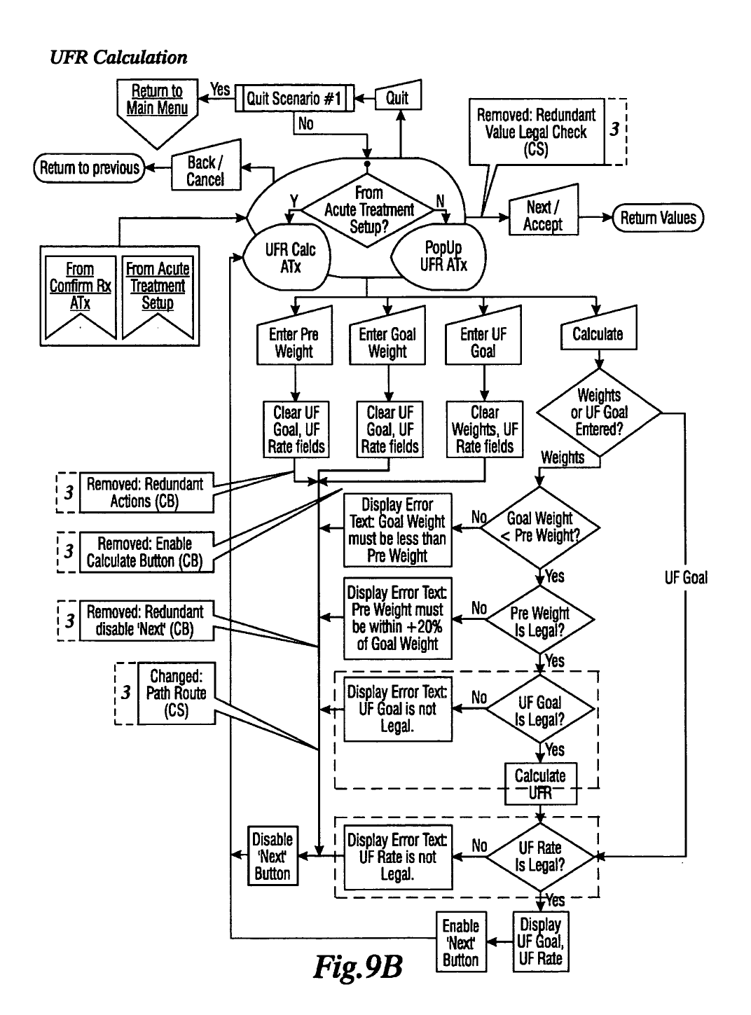

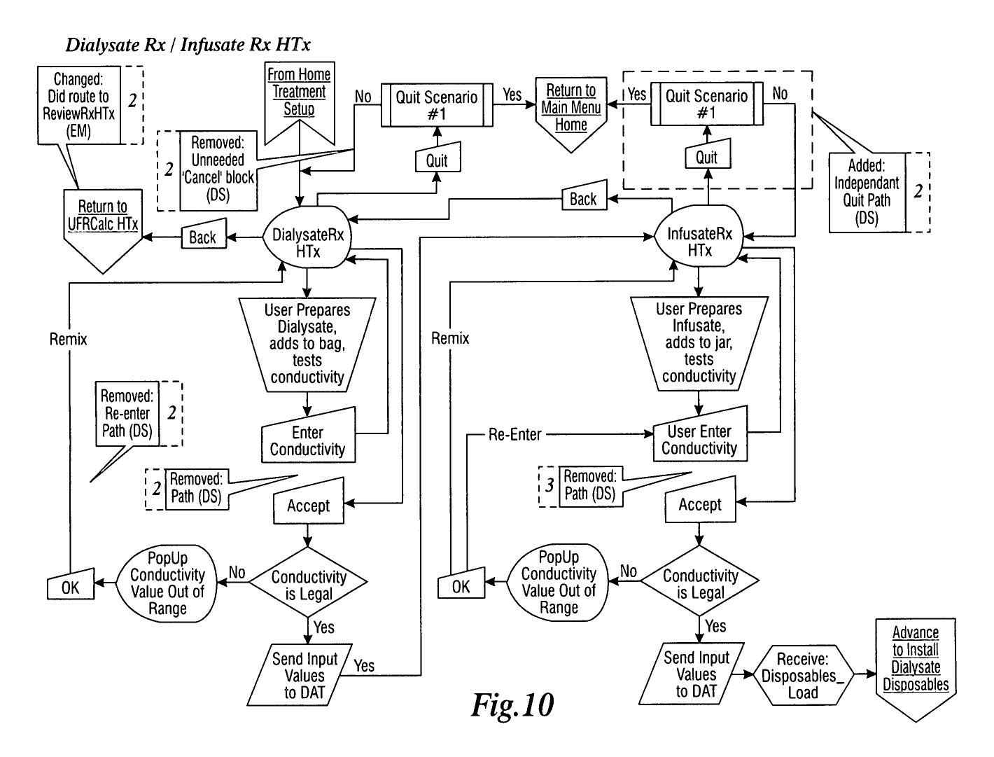

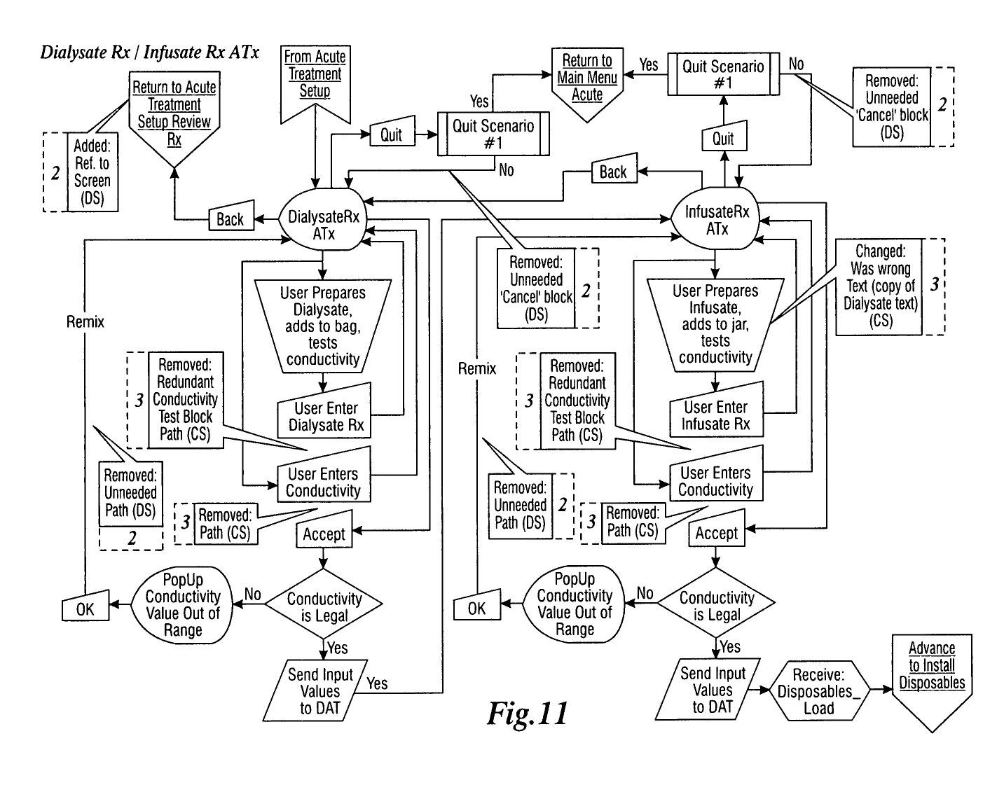

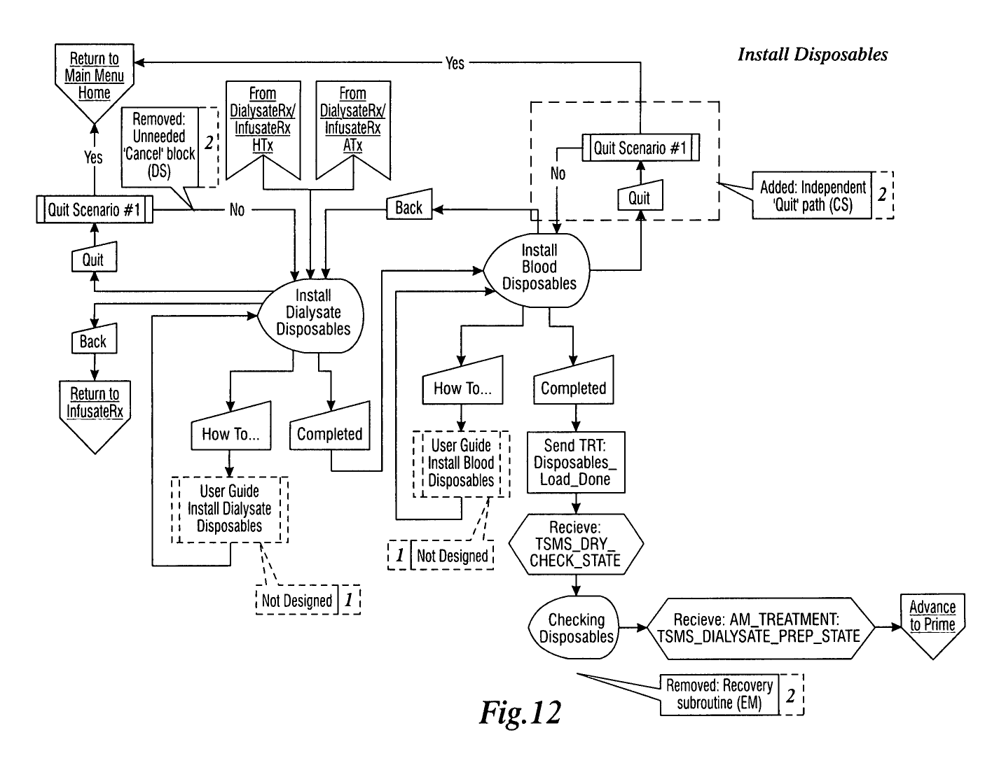

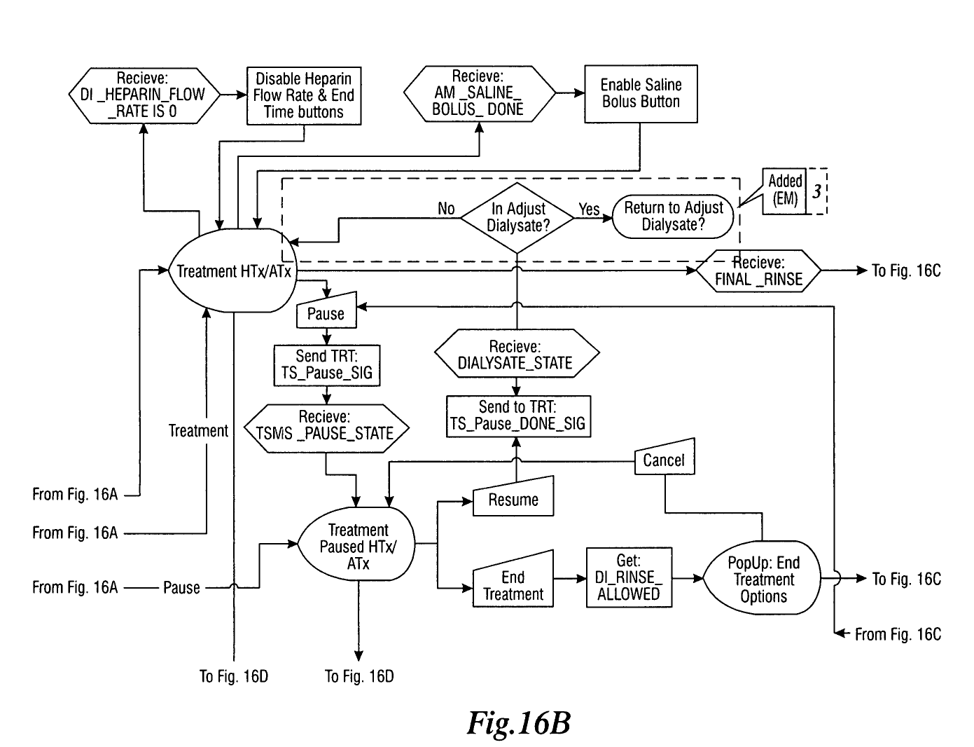

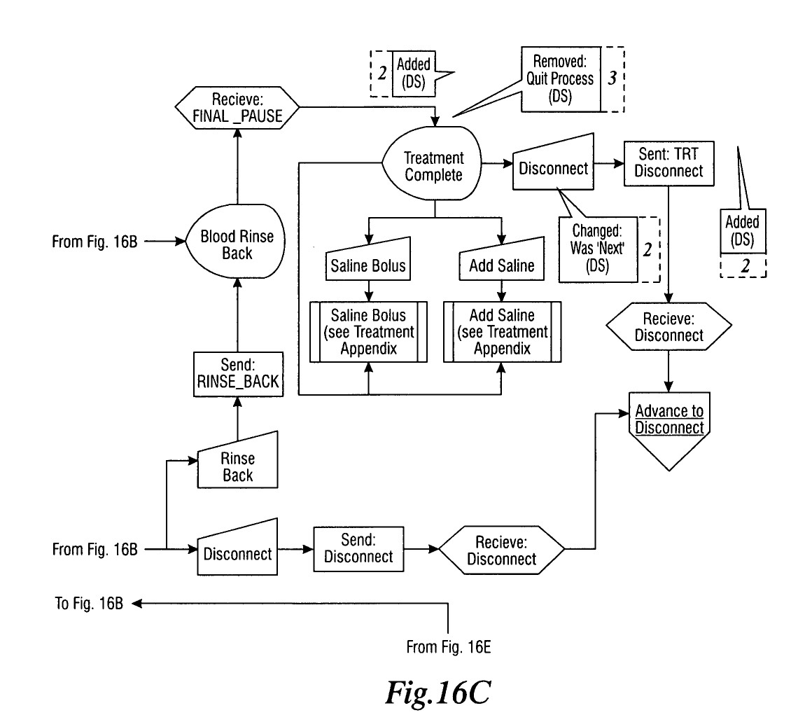

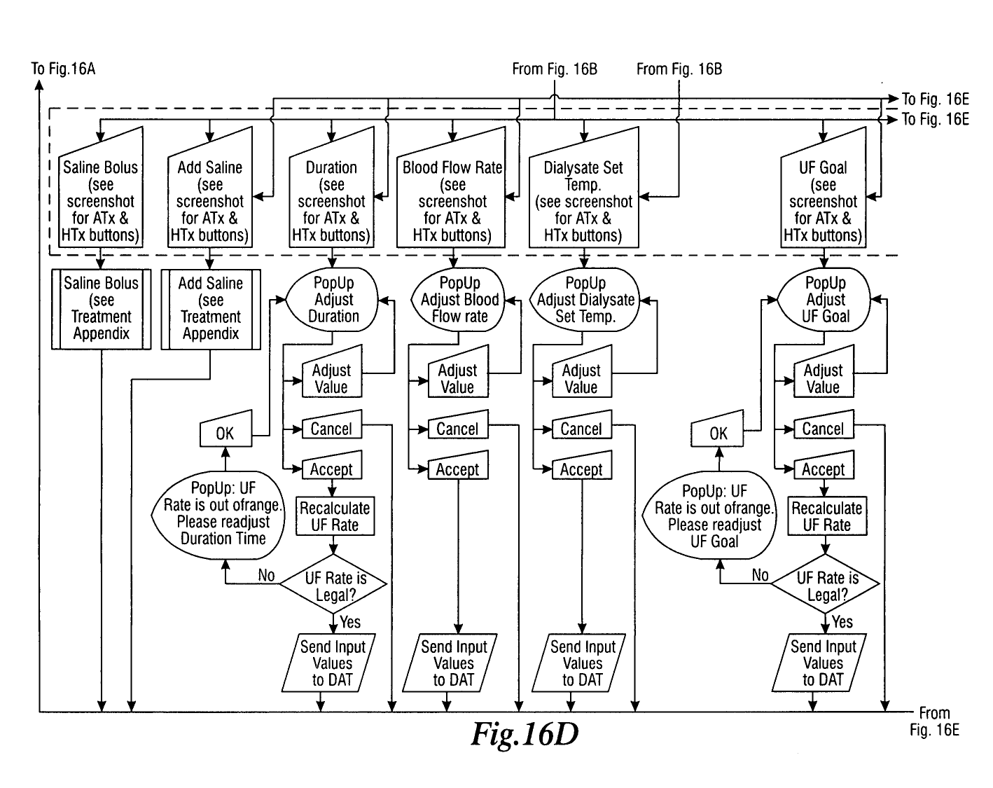

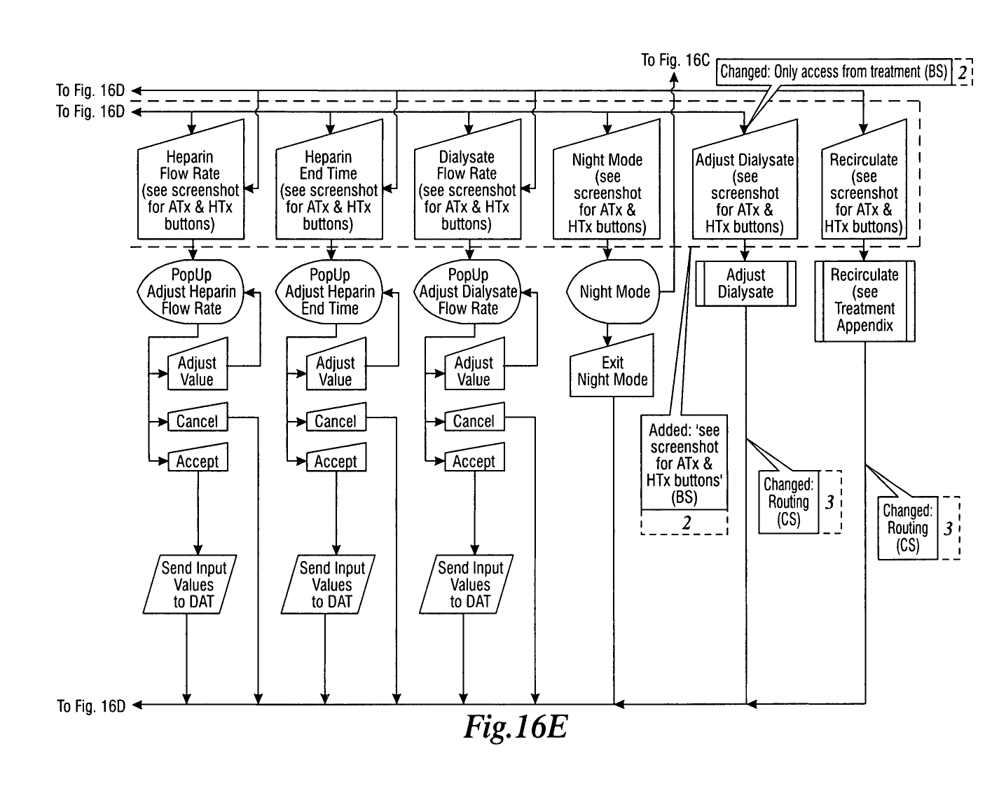

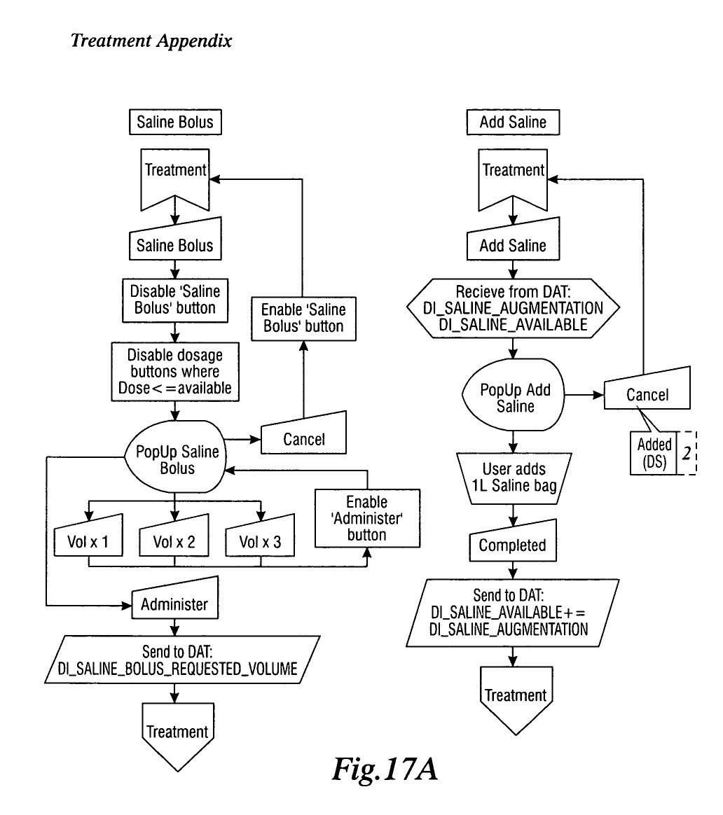

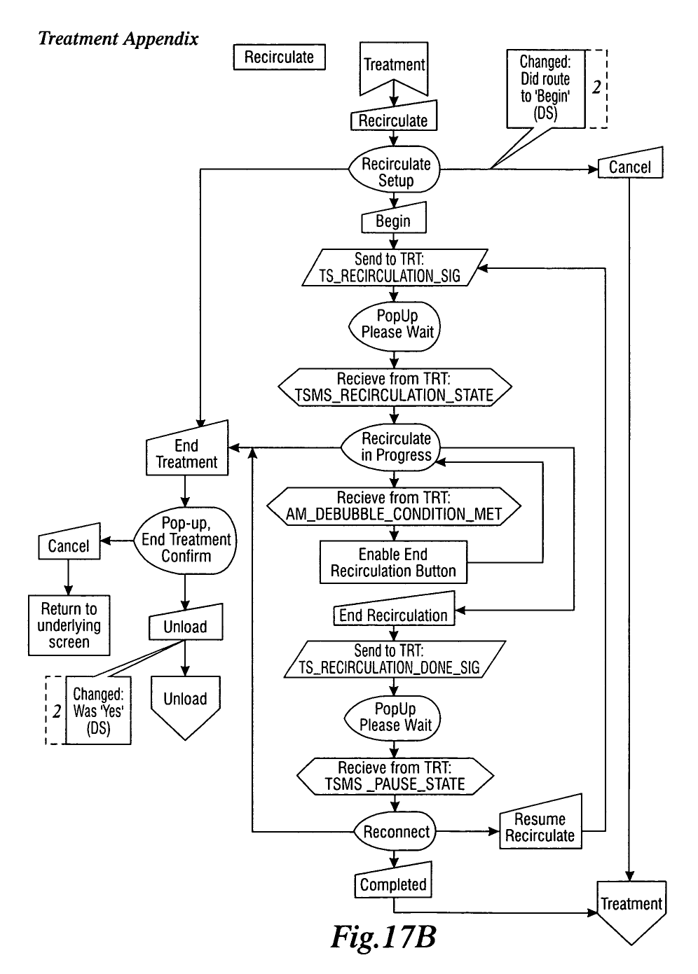

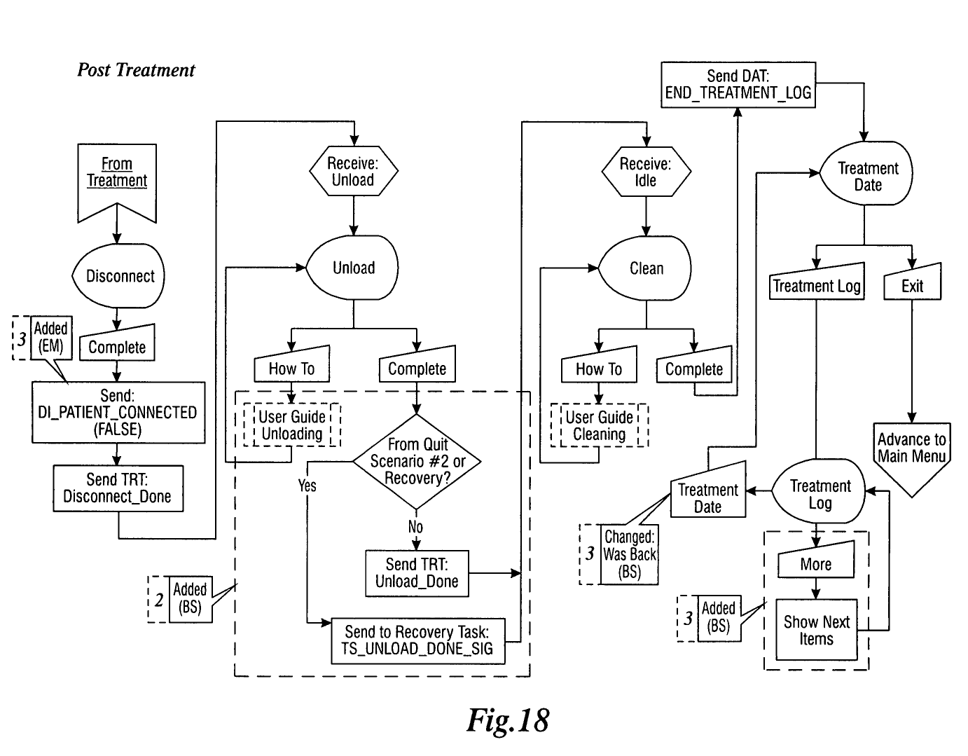

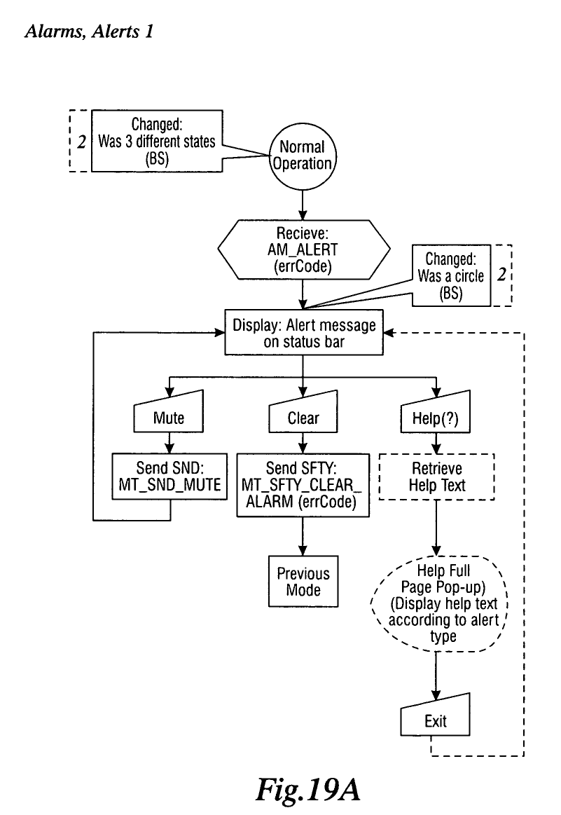

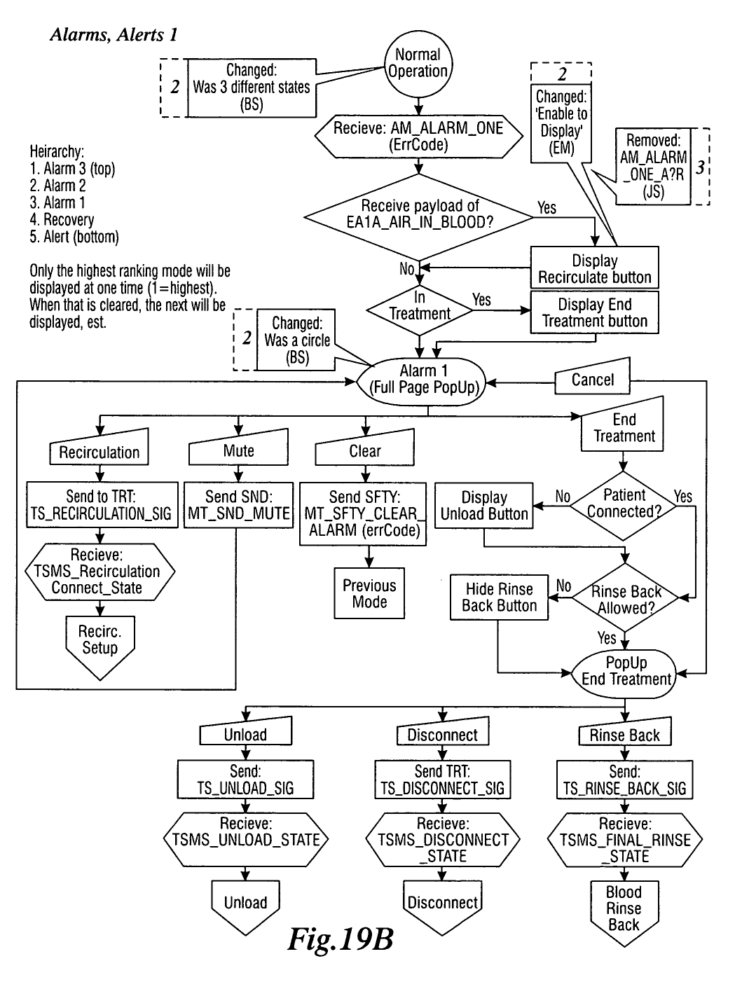

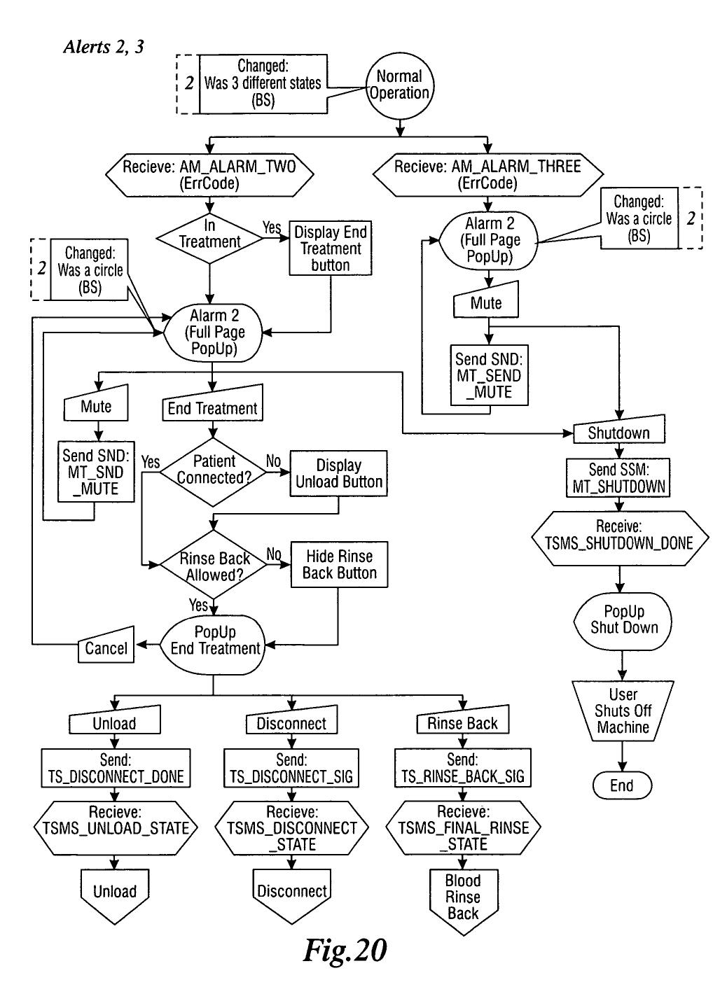

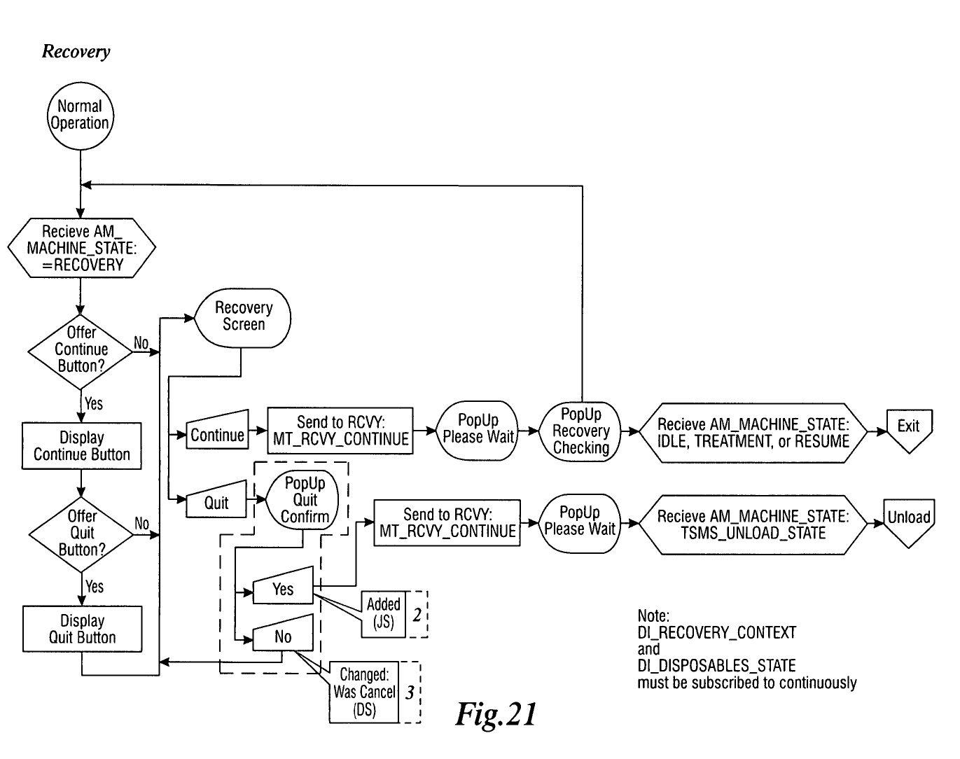

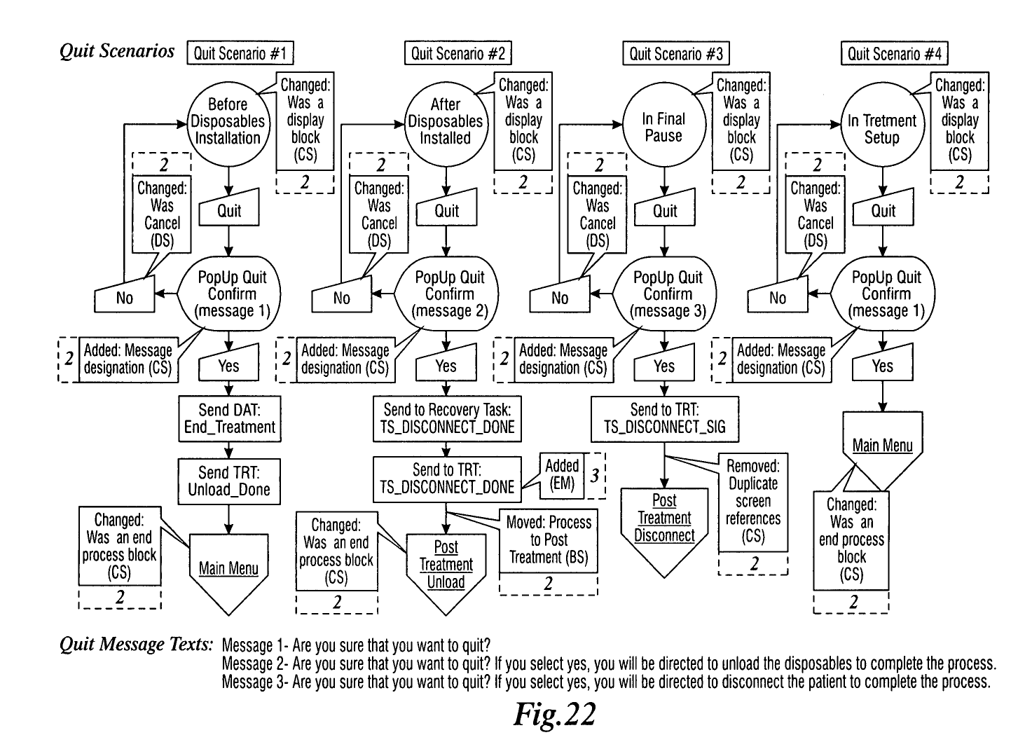

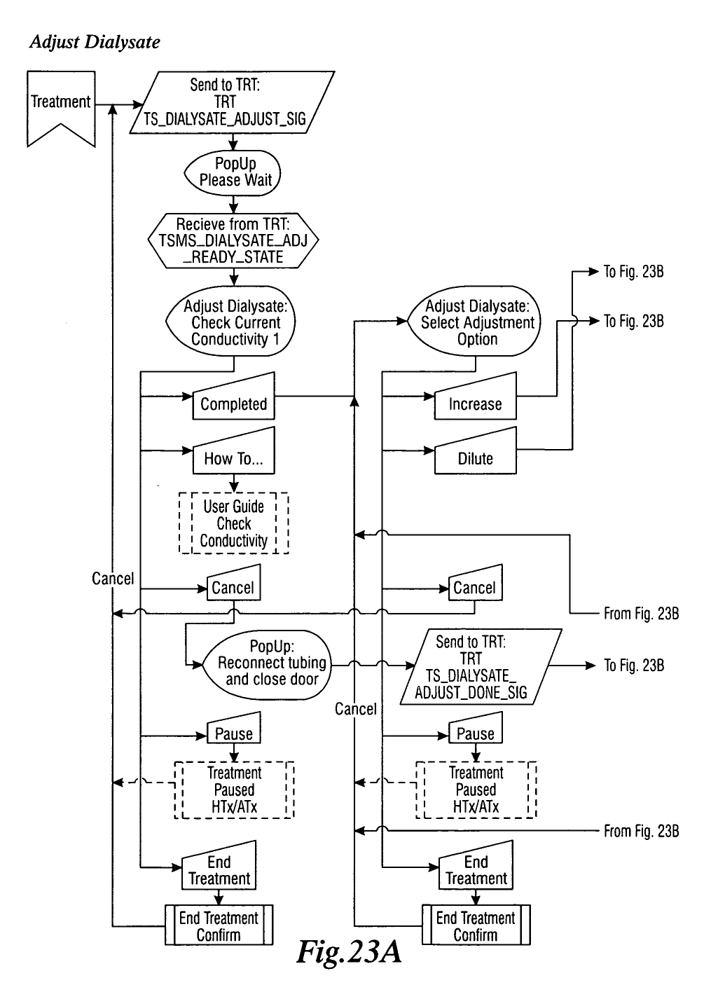

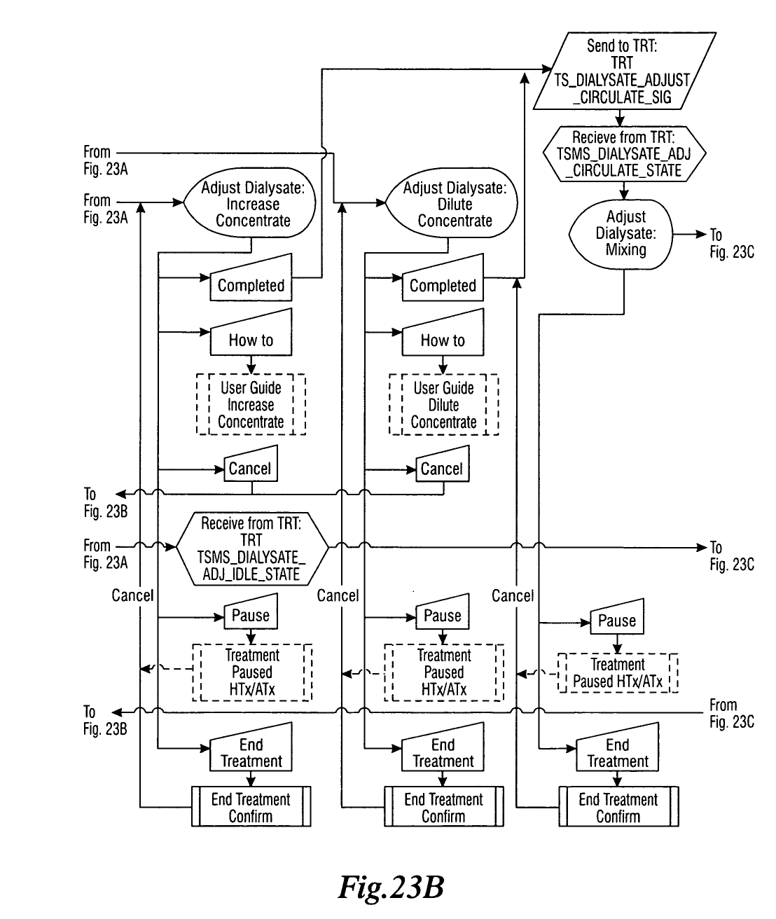

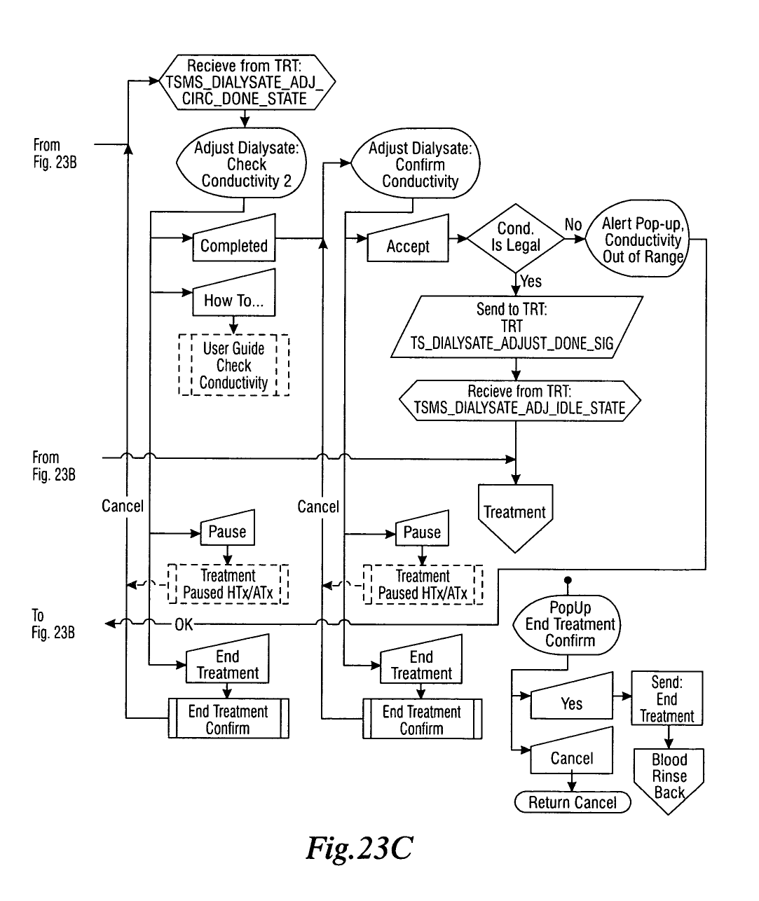

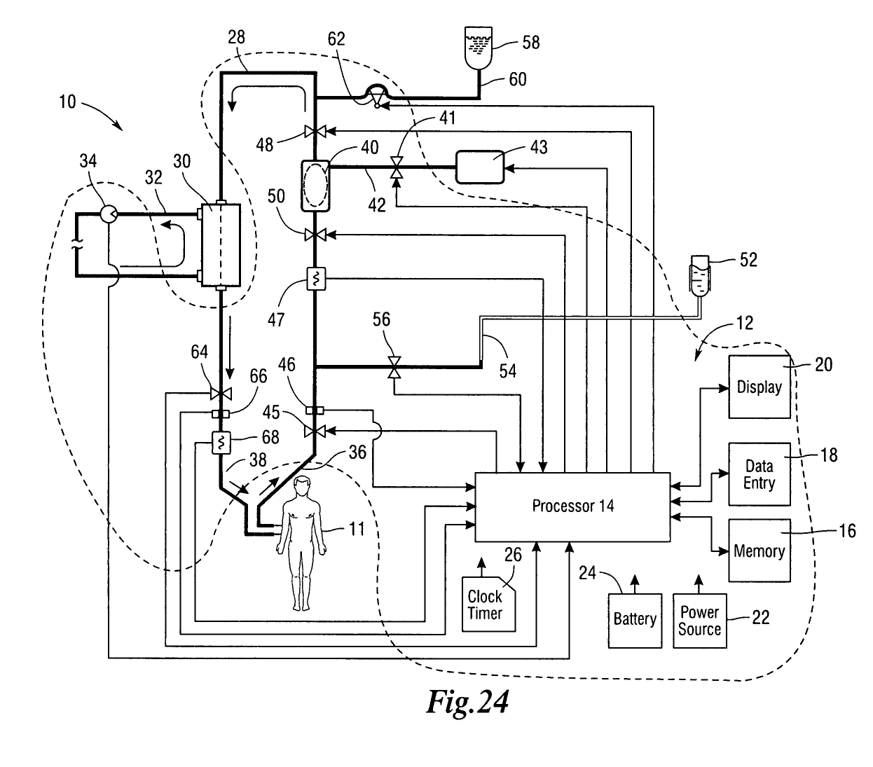

FIGS. 1-23 depict flowcharts for a preferred embodiment of the dialysis system of the present invention. FIG. 24 is a schematic of a dialysis system 10 of the present invention. Referring to FIG. 24, the system 10 is a renal dialysis system for the extracorporeal treatment of blood from a patient 11 whose kidney function is impaired. The illustrated embodiment of the dialysis system 10 of the present invention comprises a dialysis machine 12 as is generally known in the medical arts, and shown generally within the dotted line, plus various consumables as is known in the art.

In accordance with the present invention, the dialysis machine 12 is provided with a non-volatile memory component 16 adaptively coupled to electronic control means 14. Non-volatile memory component 16 can be any form of memory component that retains stored values when external power is turned off. For example, such non-volatile memory components can be selected from the group consisting of a hard disk, flash memory, battery-backed-up RAM, or other data storage device.

Dialysis machine 12 further includes a data entry device 18, such as a keyboard, touch-screen monitor, computer mouse, or the like. Dialysis machine 12 further includes a display device 20, such as a read-out monitor, for displays of operating values of the various individual components of the dialysis machine 12. The system 10 can be provided with a power source 22, a battery back-up 24, and a clock/timer 26. The processor 14, memory 16, data entry device 18, and clock/timer 26 represent one configuration of a control system.

The dialysis system 10 comprises a blood circuit 28 through which the patient's blood travels, a dialyzer 30 that serves to separate the wastes from the blood, and a dialysate circuit 32 through which treatment fluid, specifically dialysate, travels carrying the waste away.

The dialysate circuit 32 includes a dialysate pump 34 for driving dialysate fluid through a tube set and through the dialyzer 30. The dialysate circuit 32 may further include other components such as those described in U.S. patent application Ser. No. 11/148,928, entitled Dialysis System and filed on Jun. 9, 2005, which is hereby incorporated by reference in its entirety.

The blood circuit 28 includes another tube set including an arterial line 36 for withdrawing blood from the patient 11 and delivering it to the dialyzer 30, and a venous line 38 for returning the treated blood to the patient 11. A blood pump 40 drives the blood around the blood circuit 28. A valve 41 is situated on a gas line 42 for supplying negative and positive pressure from a source 43 to the pump 40. The arterial line 36 also incorporates a valve 45 that can stop the flow of blood from the patient 11, an air detector 46 that can detect air in the arterial line 36, and a flow sensor 47 that measures the flow of blood. The arterial line 36 further includes a valve 48 upstream of the pump 40 and a valve 50 downstream on the pump 40. The blood pump 40 may be configured as described in U.S. patent application Ser. No. 10/399,128, entitled Device and Methods for Body Fluid Flow Control In Extracorporeal Fluid Treatments, filed on Jul. 28, 2003, which is hereby incorporated by reference in its entirety.

Other components which interact with the blood circuit 28 include a source of fluid, such as a saline bag 52, which communicates with the arterial line 36 via a branch line 54 and a valve 56 responsive to processor 14. Additionally, an anticoagulant solution such as a heparin supply 58 may communicate with the arterial line 36 through a branch line 60 and a pump 62 responsive to processor 14. It is understood by persons skilled in the art that additional elements may be added to the blood circuit 36, such as air detectors in the branch lines 54 or 60. These additional elements are omitted from the drawings for clarity of illustration. Finally, the venous line 38, which delivers the treated blood from the dialyzer 30 to the patient 11, also includes a valve 64, an air detector 66, and a flow sensor 68.

The processor 14 coordinates the operation of the dialysis system 10 by controlling the blood flow in the blood circuit 28, the dialysate flow in the dialysate circuit 32, and the flow of saline 52 or heparin 58 to the arterial line 36 via the branch lines 54 and 60, respectively. To achieve this, the processor 14 utilizes hardware and/or software configured for operation of these components and may comprise any suitable programmable logic controller or other control device, or combination of control devices, that is programmed or otherwise configured to perform as is known in the art. Thus, blood flow in the blood circuit 28 is controlled by operating the blood pump 40 and controlling the valves in the arterial and 36 and venous 38 lines. Dialysate flow in the dialysate circuit 32 is controlled by operating the dialysate pump 34.

The processor 14 is also responsive to various input signals it receives, such as input signals from one or more flow sensors 47, 68, air detectors 46, 66, and the clock/timer 26. Additionally, the processor 14 displays system status and various other treatment parameters, known in the art, on the display 20. That allows the operator to interact with the processor 14 via the data entry device 18 (which could include a touch sensitive display 20).

The present invention can be used with a variety of different commercially available dialysis machines; one such machine particularly suited for use with the present invention is a dialysis machine sold under the registered trademark ALLIENT by Renal Solutions, Inc., the assignee of the invention herein.

The dialysis system 10 must be set up before it can be used to provide dialysis treatment for a patient. Set-up procedures are typically performed by a medically trained professional. First, the power to the machine is turned on. Data pertaining to the patient to be treated is entered by the system operator into the system via data entry device 18, and this data is stored in non-volatile memory component 16. Such data will include information to identify the patient, such as name and address, or some other indicium such as a reference number. Such data will further include prescription parameters for the dialysis process that are unique for that patient as prescribed by his or her physician. Such prescription dialysis parameters can include, for example, blood flow rate, the duration of treatment, the type of dialyzer used, the dialyzer values, the type of dialysate, the type of infusate, and values related to treatment with heparin or other anti-coagulant.

Once the applicable patient data has been entered into the non-volatile memory component 16, the operator continues to prepare the machine for patient treatment in accordance with standard medical procedures. The disposable blood lines and dialysate lines are installed, flushed, and primed. Dialysate, saline, and heparin are each loaded into their respective reservoirs. The blood lines are de-bubbled and the dialysate is warmed to the appropriate treatment temperature. These steps are carried out by the operator, interacting with electronic control means 14 via data entry device 18.

In accordance with the invention, once the dialysis machine has been set up for patient treatment, the system 10 either can proceed in treatment mode or it can be converted into “transport mode.” Electronic control means 14 sends a query via display means 20 to the operator, by which the operator can instruct the electronic control means 14 via data entry device 18 to operate in either treatment mode or transport mode. If the operator elects to have the machine 12 operate in treatment mode, then the machine 12 is connected to the waiting patient, and treatment proceeds in the standard manner.

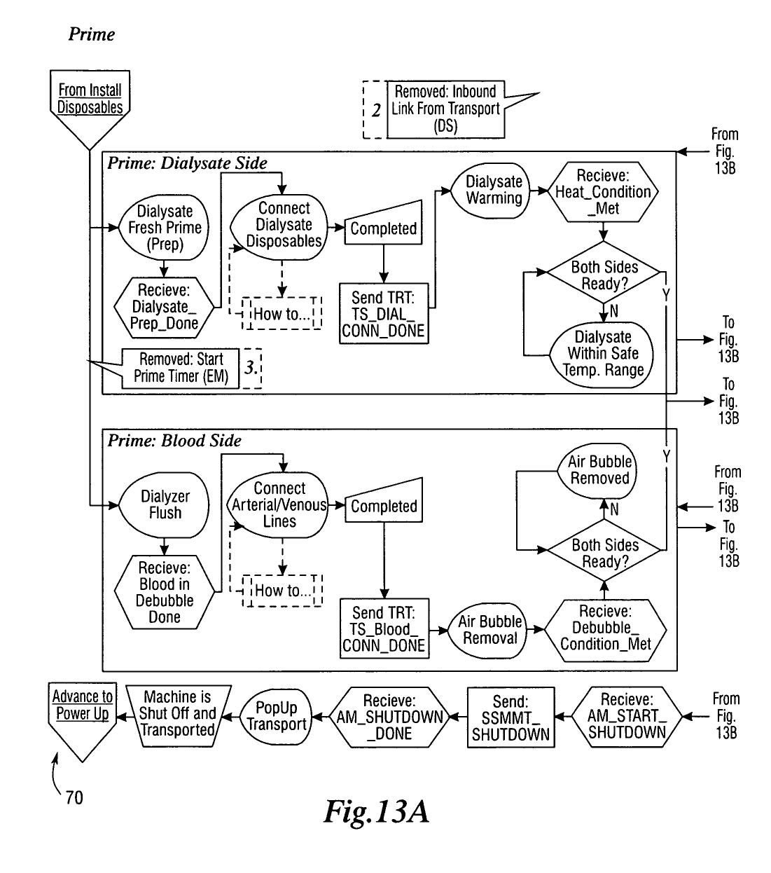

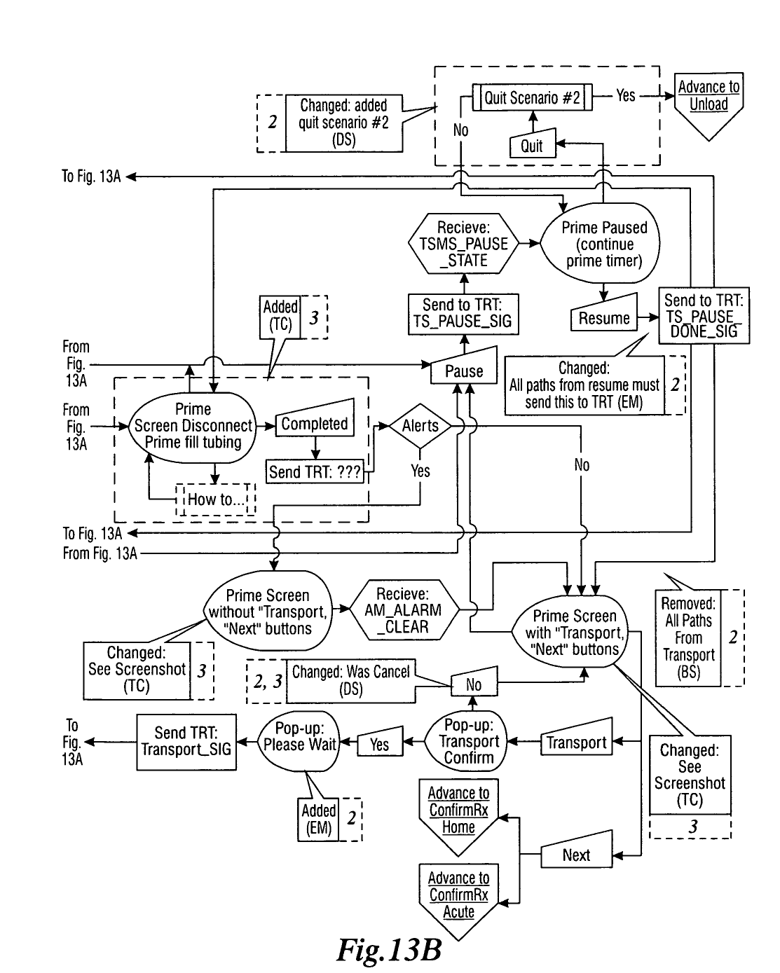

If, however, the operator instructs the machine via, for example, data entry device 18 that the machine 10 is to operate in “transport mode,” then a different sequence of steps ensues which are shown by the sequence of steps 70 in FIG. 13. Processor 14 initiates a transport mode shutdown sequence. The processor 14 stores a value to indicate that “transport mode” has been selected. That value is obtained from the clock/timer 26. The value could be, for example, a reading of a current time from the clock. Alternatively, a counter could be reset so as to start counting clock pulses. Inputs to the non-volatile memory 16 are disabled so that the memory 16 will stay in the exact state that the operator left it before initiating the transport mode sequence. The operator then disconnects the machine 12 from an external power supply (not shown). The system 10 can now be relocated to a location closer to the patient for whom it was set up, such as in a hospital room, an emergency room, or another location.

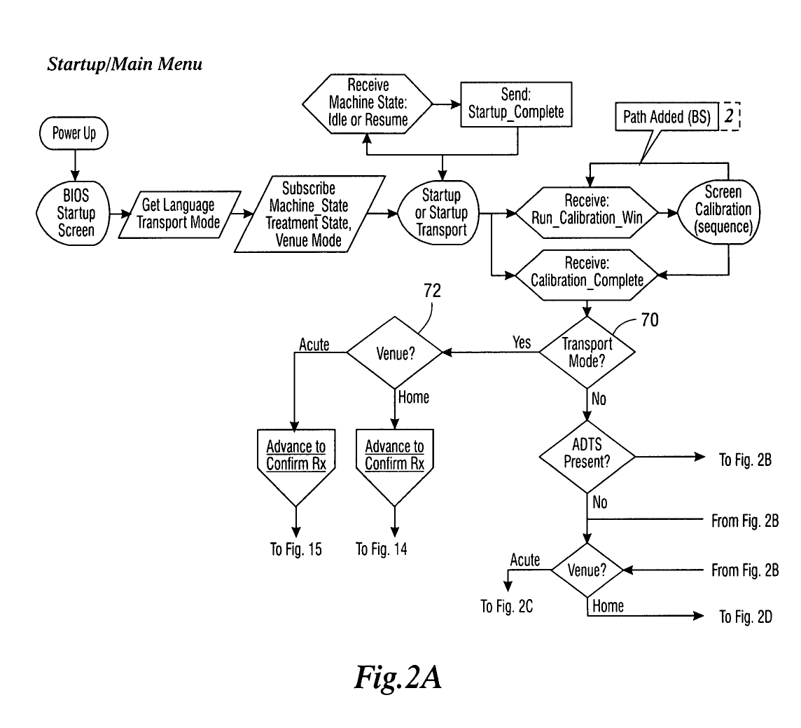

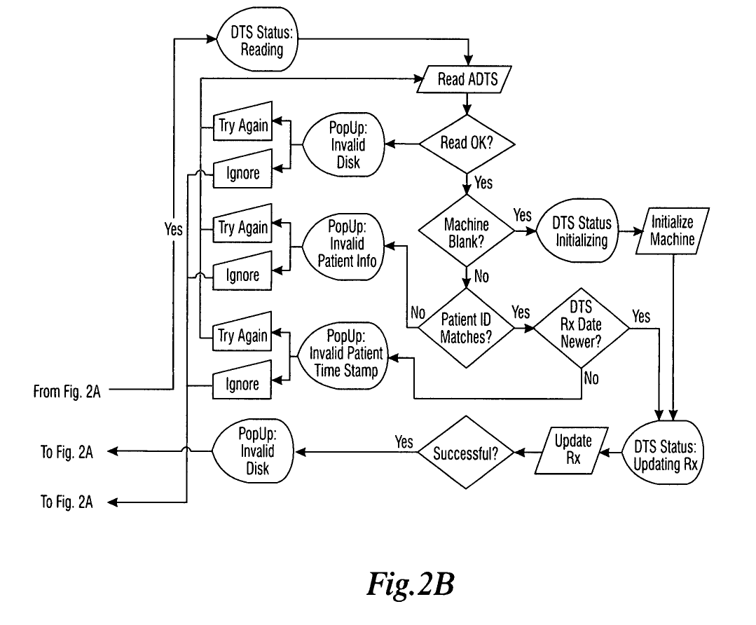

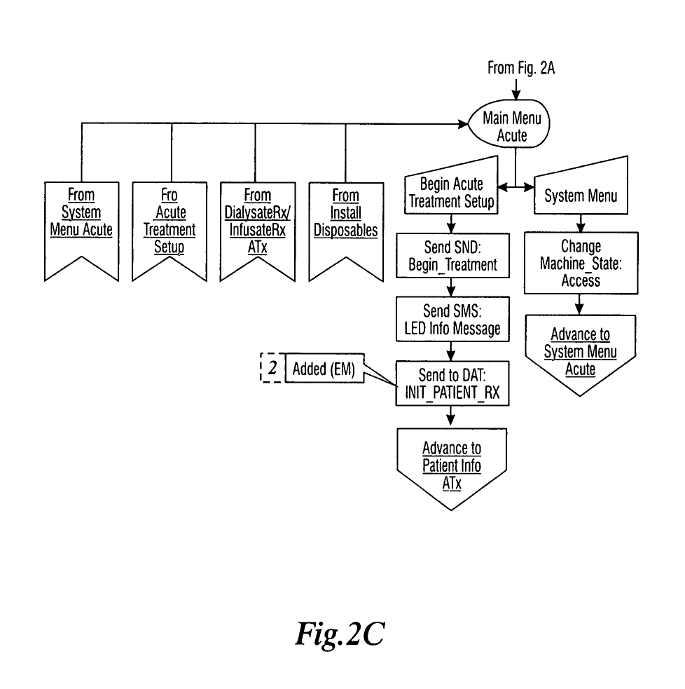

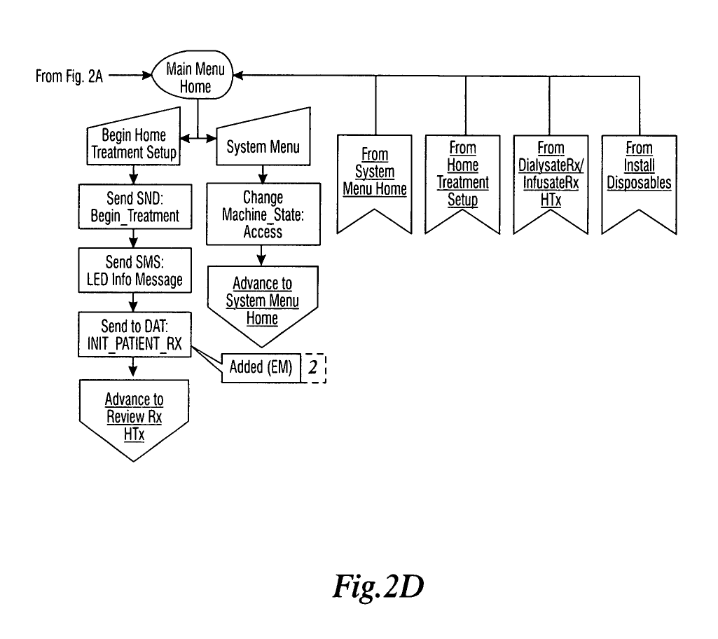

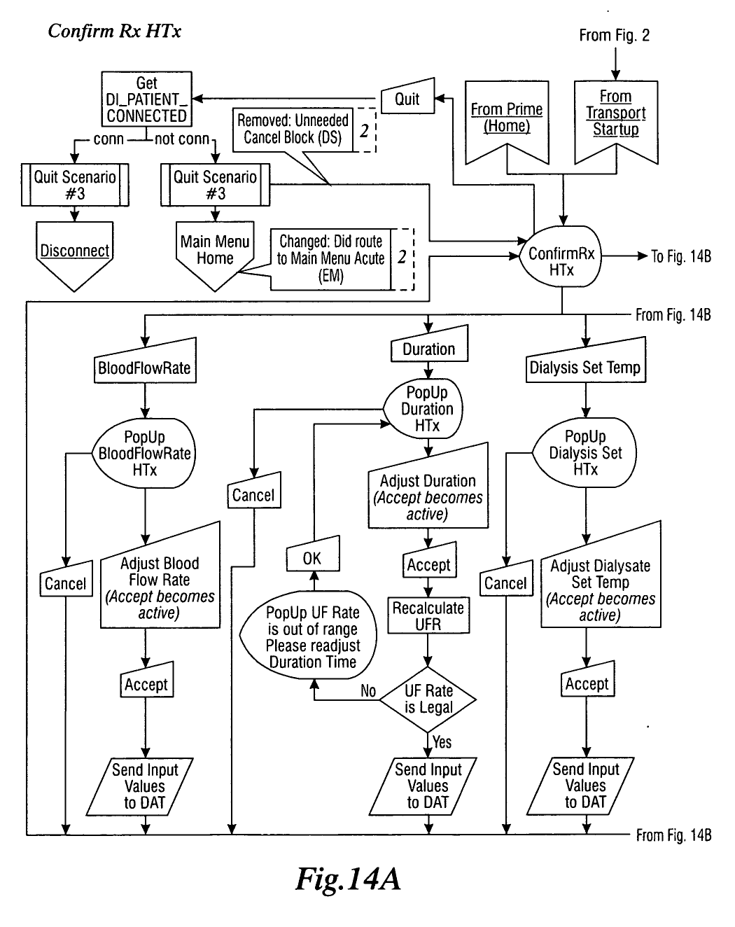

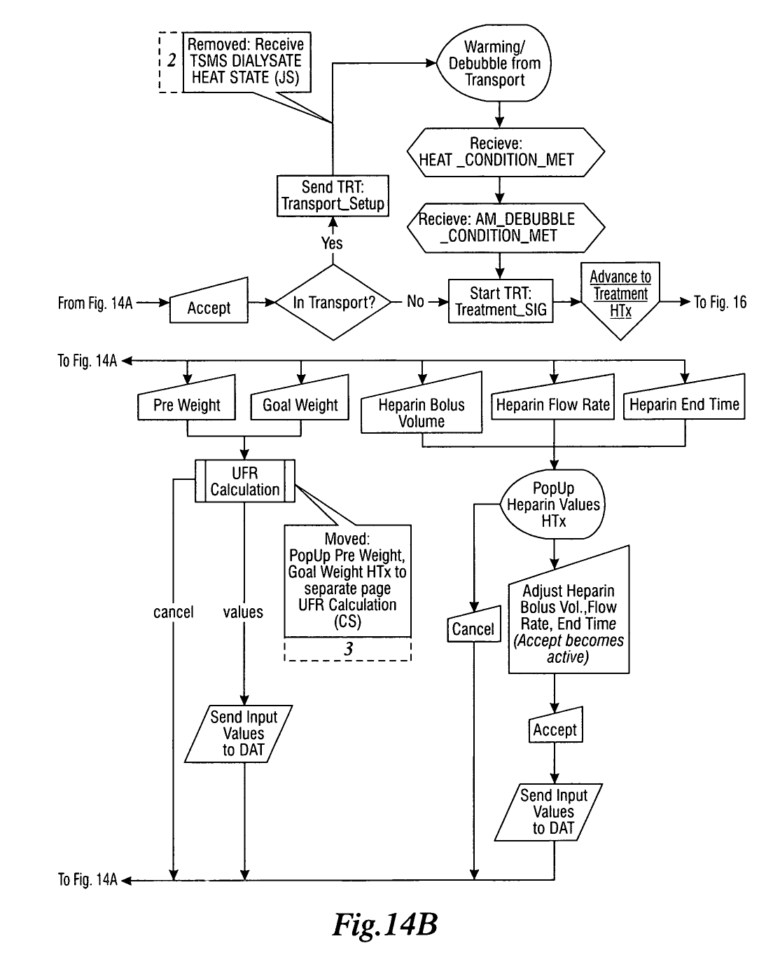

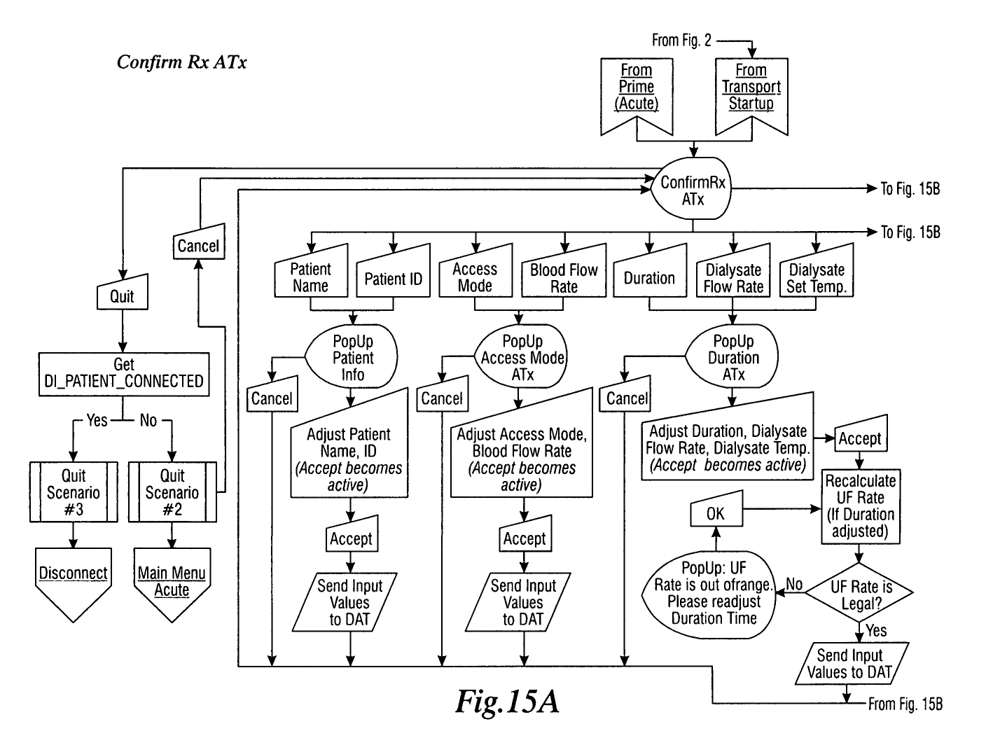

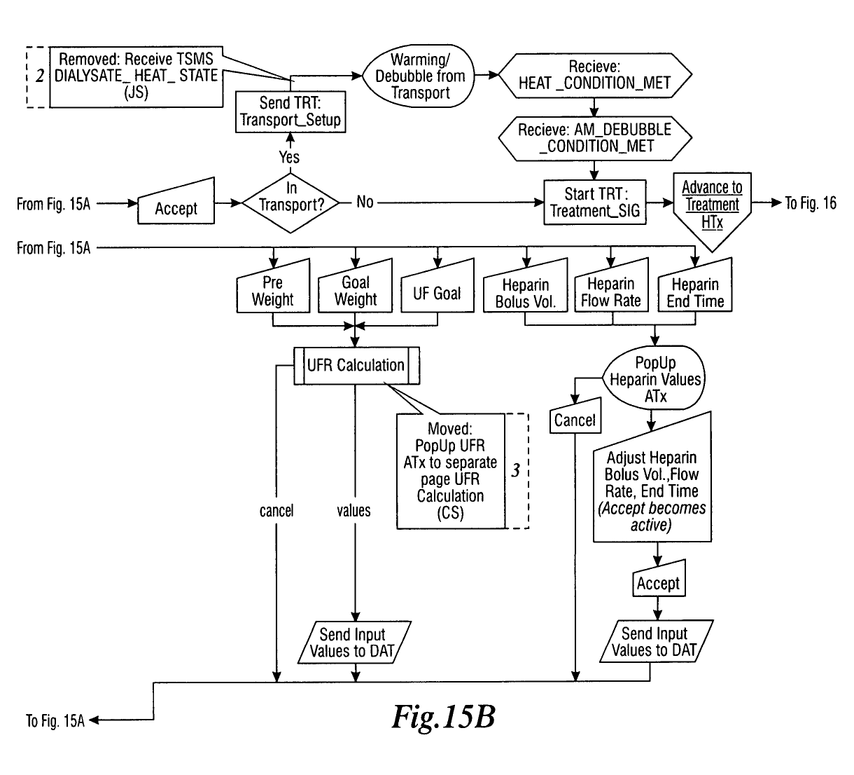

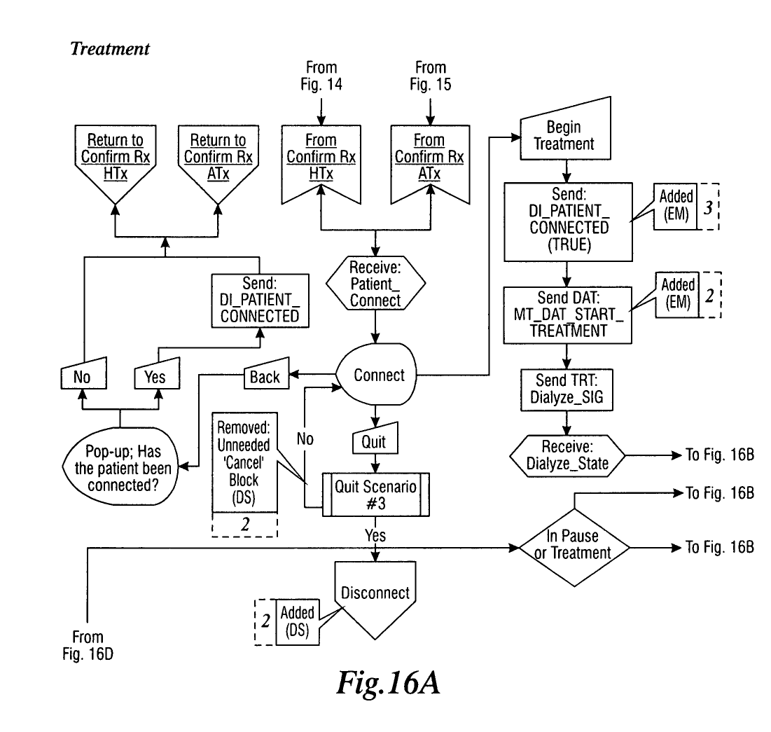

After the system 10 is relocated, the operator then reconnects the dialysis machine 12 to a power source, and initiates a start-up procedure shown generally in FIG. 2. The processor 14 first determines at step 70 whether the machine 12 had been left in transport mode at the time of shut down. If it was, a determination of the venue is made at step 72. For the acute care venue, the process continues with the Confirm Rₓ Aₓ procedure shown in FIG. 15. For the home care venue, the process continues with the Confirm Rₓ Hₓ procedure shown in FIG. 14. In either case, the machine 12 performs several different checks of the system 10 to assure that transition into treatment mode is still a viable option. For example, the processor 14 checks that the disposable blood and dialysate lines are still connected and loaded; that the dialysate and infusate volumes are still correct; and that the tubing contains fluid. If any of these conditions are not met, then the processor 14 will send a signal to the display means 20 to advise the operator of the particular situation that must be corrected.

In a preferred embodiment, the control system is provided with a real-time clock or other timekeeping device 26 that maintains operation when external power has been disconnected. The processor 14 checks the timekeeping device 26 to determine if too much time has elapsed from the time external power was first disconnected. There are various ways in which that may be implemented. For example, upon entering the transport mode, a value from the clock may be read. Upon bringing the machine out of the transport mode, another reading from the clock may be taken. The length of time that the system was in the transport mode may be determined by comparing the two clock readings to calculate the difference between the clock readings. That difference may then be compared to a predetermined value.

In another embodiment, a counter may be reset or initiated when the machine is put into the transport mode. Upon bringing the machine out of the transport mode, the value of the counter may be read. The value which is read may then be compared to a predetermined value.

It is presently believed that no more than about two to two and one-half hours should elapse between the time that power is shut down for the transport mode of operation and the time patient treatment is initiated to protect against unacceptable bacterial growth that may occur in the various lines of the system. If too much time has elapsed, then the operator would dispose of the dialysate and infusate and begin the start-up sequence anew.

The dialysate reservoir will be provided with a temperature sensor in communication with the processor 14. The processor 14 will read the temperature sensor to determine whether the dialysate temperature is within an acceptable range, which according to general medical principles will be in the range of about 34-39° C. If the temperature is outside this range, the processor 14 will direct the machine to heat the dialysate or allow it to cool to bring it into the acceptable temperature range before the time limit expires. The processor 14 will also cause the machine to initiate an automatic de-bubbling sequence to ensure that any air that may have been inadvertently introduced into the blood lines is eliminated. Completion of this sequence can be indicated on display means 20.

Once all system checks are complete, the system will provide a signal, such as a notice on display means 20, indicating that the system is ready to commence dialysis treatment of a patient. Preferably, the system displays the patient's identifying data a treatment parameters on display means 20, so that the operator can verify that the correct patient is about to be treated and that the treatment parameters are correct.

In one embodiment, if the system determines that none of the disposable elements are installed, it will assume that the operator purposely removed those components during the time when external power was disconnected. Then, instead of providing the operator with the option of treatment mode, the machine will resume normal start-up procedures and require the loading of disposable elements and entry of patient identification and treatment data as if transport mode had not been initiated.

As previously described, the transport mode allows the user to prepare the machine for treatment by loading disposables and proceeding through system prime. At that point the user may elect, instead of starting a treatment, to shutdown the machine to transport it to the point of use. There is a limit of two to two and one-half hours from the time that the dialysate is mixed to the actual start of dialysis (Prime Time). The following table details that process.

TABLE 1
MACHINE_STATE is IDLE.
The User enters prescription information.
The User mixes and measures the dialysate conductivity.
The User enters the dialysate conductivity and presses the Accept button
on the Dialysate screen.
GUI sends TRT a SETUP_SIG.
TRT changes MACHINE_STATE to TREATMENT.
TRT sends DAT a DIALYSATE_MIXED message. DAT will record
the real-time clock as the start time of Dialysate Mixed. TRT will
initialize its Prime Timer count-down timer with 2.5 hours.
TRT, GUI, and the User continue with infusate mixing, disposable
loading, and System Prime.
TRT sends GUI the BUBBLE_COND_MET and HEAT_COND_MET
messages to signal GUI that it's OK to start Treatment or Transport.
The operator decides to enter Transport Mode.
GUI sends a TRANSPORT_SIG to TRT.
TRT changes MACHINE_STATE to TRANSPORT.
TRT sends DAT a DATA_CHANGE to set TRANSPORT_MODE data
indicator to true.
DAT sends GUI a START_SHUTDOWN message.
GUI initiates the shutdown of the Main Controller (processor 14) by
sending SSM a SHUTDOWN message.
After SSM determines that all components have shutdown SSM sends
GUI a SHUTDOWN_DONE message. GUI then puts up a screen to tell
the operator to turn off power to the machine.
The machine is powered off and then back on. Subsequent steps
start when the Main Controller enters the CHECKING
MACHINE_STATE.
SFTY requests TRANSPORT_MODE from DAT and realizes that this
machine is powered up in Transport Mode because
TRANSPORT_MODE is true.
SFTY sends a CHANGE_SCREEN to GUI to tell GUI to change the
screen to “Transport Startup.”
SFTY sends the remotes several commands to determine if the
disposables are installed on the machine (a Wet Check). SFTY does
several tests:

If SFTY determines that there are no disposables on the machine
the MACHINE_STATE is set to IDLE and
TRANSPORT_MODE is set to false. GUI sees that
MACHINE_STATE is IDLE and presents a non-transport Main
Menu.
SFTY asks DAT for the elapsed Dialysate Mixed time, which is
the difference between the current real-time clock and the time
that the dialysate was first mixed. If the elapsed Dialysate
Mixed time is over 2.5 hours SFTY changes
MACHINE_STATE to RECOVER and offers a Recovery screen
with only the Quit button available. Pressing the Quit button
will cause the Unload screen to be presented. The machine must
be unloaded and power-cycled to start another treatment.
If SFTY determines that there are some disposables missing the
MACHINE_STATE is set to RECOVER and the user is given
the opportunity to correct the missing disposable(s). Repeat Wet
Check with MACHINE_STATE set to CHECKING if the user
presses the Continue button on the Recovery screen.

If all the disposables are loaded and the Dialysate Mixed time is under
2.5 hours SFTY changes MACHINE_STATE to RESUME (from
CHECKING).
GUI observes the MACHINE_STATE is RESUME and asks the
operator to confirm the patient prescription.
IF the operator confirms the patient prescription GUI will send TRT a
TRANSPORT_SETUP_SIG to resume the treatment.
TRT asks DAT for the elapsed Dialysate Mixed time.
If the elapsed Dialysate Mixed time is greater than 2.5 hours TRT will
post an Alarm Two.
If the elapsed Dialysate Mixed time is less than 2.5 hours TRT will
initialize its Prime Time count-down timer with 2.5 hours minus the
elapsed Dialysate Mixed time received from DAT.
TRT changes MACHINE_STATE to TREATMENT.
TRT enters the SYSTEM_PRIME state to ensure that the dialysate is at
the correct temperature and that the blood-side is still bubble free.
When TRT has confirmed de-bubbling and dialysate temperature TRT
sends GUI DEBUBBLE_COND_MET and HEAT_COND_MET
messages.
GUI receives DEBUBBLE_COND_MET and HEAT_COND_MET
messages and asks the operator to connect the patient. The Transport
Mode option is not allowed at this time. When the patient is connected
GUI sends TRT a DIALYZE_SIG. DIALYZE_SIG must be sent before
TRT's Prime Timer count-down timer expires.
TRT will send DAT a DATA_CHANGE to set TRANSPORT_MODE
to false. No more power cycles are allowed.
TRT proceeds with dialysis if the Prime Timer count-down timer has
not expired.

The foregoing description of a preferred embodiment of the invention is presented by way of illustration and not by way of limitation. It is to be understood that any changes, modifications and equivalents that come within the spirit of the invention are to be covered by the following claims.

What is claimed is:

1. A control system for a dialysis machine, said control system comprising:
an input device for receiving information;
a non-volatile memory device responsive to said input device for storing information;
a clock; and
a processor responsive to said memory device for implementing a treatment, said processor responsive to said input device for entering a transport mode, said processor further responsive to said clock such that said processor is prevented from implementing said treatment after a predetermined time in said transport mode has elapsed; and
an output device responsive to said processor.

2. The control system of claim 1 wherein said information comprises instructions for implementing said treatment and said transport mode, said information additionally comprising parameters for said treatment.

3. The control system of claim 1 additionally comprising a battery for supplying power to said non-volatile memory device.

4. A dialysis machine, comprising:
a first pump and a first plurality of valves for moving blood through a blood circuit;
a second pump for moving dialysate through a dialysate circuit;
an input device for receiving information;
a non-volatile memory device responsive to said input device, for storing information;
a clock; and
a processor responsive to said memory device for providing control signals to said first and second pumps and said first plurality of valves for implementing a treatment, said processor responsive to said input device for entering a transport mode, said processor further responsive to said clock such that said processor is prevented from implementing said treatment after a predetermined time in said transport mode has elapsed; and
an output device responsive to said processor.

5. The dialysis machine of claim 4 additionally comprising a first branch line responsive to a source of saline and a first branch line valve responsive to said processor for inputting saline to said blood circuit.

6. The dialysis machine of claim 4 additionally comprising a second branch line responsive to a source of heparin and a branch line pump responsive to said processor for inputting heparin to said blood circuit.

7. The dialysis machine of claim 4 additionally comprising a flow detector and an air detector for monitoring said blood circuit, said processor being responsive to said flow detector and said air detector.

8. A dialysis system comprising, comprising:
a blood circuit comprising a first pump and a first plurality of valves for moving blood through a first tube set;
a dialysate circuit comprising a second pump for moving dialysate through a second tube set and a dialyzer;
an input device for receiving information;
a non-volatile memory device responsive to said input device, for storing information;
a clock; and
a processor responsive to said memory device for providing control signals to said first and second pumps and said first plurality of valves for implementing a treatment, said processor responsive to said input device for entering a transport mode, said processor further responsive to said clock such that said processor is prevented from implementing said treatment after a predetermined time in said transport mode has elapsed; and
an output device responsive to said processor.

9. The system of claim 8 additionally comprising a first branch line responsive to a source of saline and a first branch line valve responsive to said processor for inputting saline to said blood circuit.

10. The system of claim 8 additionally comprising a second branch line responsive to a source of heparin and a branch line pump responsive to said processor for inputting heparin to said blood circuit.

11. The system of claim 8 additionally comprising a flow detector and an air detector for monitoring said blood circuit, said processor being responsive to said flow detector and said air detector.

12. A method of operating a dialysis machine, comprising:
receiving data at an input device;
storing said received data in a non-volatile memory device;
generating timing information; and
using said timing information to determine if said dialysis machine may be used to administer a treatment.

13. The method of claim 12 wherein said generating comprises saving a first clock reading when said machine is placed in said transport mode and saving a second clock reading when said machine is brought out of said transport mode, and wherein said using comprises calculating the difference between said first and second clock readings and comparing said difference to a predetermined value.

14. The method of claim 13 wherein said predetermined value represents a time period that is about two and one-half hours.

15. The method of claim 12 wherein said generating comprises initiating a counter when said machine is placed in said transport mode and reading said counter when said machine is brought out of said transport mode, and wherein said using comprises comparing the read value to a predetermined value.

16. The method of claim 15 wherein said predetermined value represents a time period that is about two and one-half hours.

17. A method of operating a dialysis system comprising a dialysis machine and consumables, said method comprising:
preparing a dialysis machine to deliver a treatment;
placing said machine in a transport mode;
transporting said system to a treatment location;
bringing said machine out of said transport mode;
determining the length of the time that said system was in said transport mode; and
using said length of time to determine if said system should be used to deliver a treatment.

18. The method of claim 17 wherein said preparing a machine to deliver a treatment comprises attaching consumables to said dialysis machine and entering dialysis treatment parameters for a patient into said machine.

19. The method of claim 17 wherein said determining comprises saving a first clock reading when said machine is placed in said transport mode, saving a second clock reading when said machine is brought out of said transport mode, and calculating the difference between said first and second clock readings, and wherein said using comprises comparing said difference to a predetermined value.

20. The method of claim 19 wherein said predetermined value represents a time period that is between two and two and one-half hours.

21. The method of claim 17 wherein said determining comprises initiating a counter when said machine is placed in said transport mode, and reading said counter when said machine is brought out of said transport mode, and wherein said using comprises comparing the read value to a predetermined value.

22. The method of claim 21 wherein said predetermined value represents a time period that is between two and two and one-half hours.
